(19) United States
(12) Patent Application Publication
(10) Pub. No.: US 2004/0070565 A1
(43) Pub. Date: Apr. 15, 2004

(54) Method and apparatus for displaying images

(76) Inventors: Shree K Nayar, New York, NY (US); Peter Belhumeur, New York, NY (US); Terrance E. Boult, Bethlehem, PA (US)

Correspondence Address: BAKER & BOTTS, 30 ROCKEFELLER PLAZA, NEW YORK, NY, 10112

(21) Appl. No.: 10/416,069

(22) PCT Filed: Dec. 5, 2001
(86) PCT No.: PCT/US01/47303

(51) Int. Cl. G09G 5/00

(52) U.S. Cl. 345/156

(57) ABSTRACT

An image-displaying method and apparatus adds, or compensates for, effects associated with environmental lighting shining on the display region, and/or imperfections in the display system hardware or display surface. By detecting the environmental illumination, the system can render an image which simulates 2-d or 3-d content (i.e., objects) as if the content were actually illuminated by the environmental lighting. Information regarding the environmental lighting can also be used to cancel out spurious bright spots caused by environmental lighting patterns shining on the display region. In addition, the image displayed in the display region can be monitored for accuracy, and can be adjusted to correct for errors caused by, e.g., spurious bright spots, imperfections in the display system characteristics, and/or imperfections in or on the surface of the display region.

### CROSS-REFERENCE TO RELATED APPLICATION

This application claims priority to U.S. Provisional Application entitled “Lighting Sensitive Displays,” Serial No. 60/251,438, filed on Dec. 5, 2001, which is incorporated herein by reference in its entirety.

### STATEMENT REGARDING FEDERALLY SPONSORED RESEARCH OR DEVELOPMENT

This invention was partially made with U.S. Government support from The National Science Foundation, Award No. IIS-00-85864. Accordingly, the U.S. Government may have certain rights in this invention.

### BACKGROUND OF THE INVENTION

Display devices such as cathode ray tube (CRTs) and liquid crystal displays (LCDs) are widely used for conveying visual information in entertainment, business, education, and other settings. Such displays are typically used under a wide variety of different lighting conditions. It is especially common for portable devices such as laptop computers and personal digital assistants (PDAs) to be used under varied and changing lighting conditions. Some conventional devices include manual controls which enable the user to globally adjust their brightness, contrast, and color settings. However, such global adjustments fail to take into account non-uniformities in environmental illumination. Consequently, the quality of the image seen by the user is sub-optimal.

In addition, there is a market for technology to enable potential customers to view products remotely before purchasing the products. Display systems are sometimes used for this purpose. However, conventional display systems present the products in a manner which assumes a predetermined set of illumination conditions; such systems fail to take into account illumination conditions in the environment of the potential purchaser. This limitation can be particularly important for purchases in which the appearance (e.g., the color and/or texture) of the product is important to the purchaser.

Non-uniform or bright environmental lighting is not the only source of interference with the viewer's accurate perception of an image. The display system itself can introduce errors in the presentation of the image. Such errors can, for example, be caused by imperfections such as non-uniformity of display characteristics. In order to compensate for such errors, some conventional systems allow the user to make crude, manual adjustments which affect the entire display area. However, such adjustments not only fail to automatically take into account what the viewer actually sees, but also fail to correct for errors which are non-uniform in nature.

### SUMMARY OF THE INVENTION

It is therefore an object of the present invention to provide an image-displaying system which detects environmental lighting conditions and adjusts the displayed image in order to compensate for degradation of the displayed image caused by the environmental lighting.

It is a further object of the present invention to provide an image-displaying system which detects environmental lighting conditions and presents an image of an object as if illuminated by the environmental lighting conditions.

It is yet another object of the present invention to provide an image-displaying system which detects a displayed image as actually seen by a viewer, and adjusts the displayed image in order to provide the viewer with a more accurate view of the image.

These and other objects are accomplished by the following aspects of the present invention.

In accordance with one aspect of the present invention, an imaging system receives information regarding the characteristics of one or more environmental light rays incident upon a display region. The characteristics of each environmental light ray include its location, direction, brightness, and/or color. The system also receives information regarding one or more geometrical and/or reflectance characteristics of an object to be displayed. The light ray information and the geometrical and reflectance information are used to generate an image of the object as if the object were illuminated by the incident environmental light; the resulting image is displayed in the display region.

In accordance with an additional aspect of the present invention, a display device receives a first signal representing the brightness and/or color of a first image portion (e.g., a first pixel or other portion) and uses the first signal to display a corresponding second image portion (e.g., a corresponding pixel or other portion) in a first portion (e.g., a single-pixel area or other area) of a display region. The displayed image portion is an approximation of the first image portion. A light signal coming from the first portion of the display region is detected during the display of the second image portion, and the brightness and/or color of the light signal is determined. The system computes the difference between the respective brightness and/or color values of the input image and the detected image portion. The difference is used to determine how much to adjust the first signal or subsequent signals associated with the first portion of the display region, in order to provide a more accurate image.

In accordance with another aspect of the present invention, an imaging system receives a first signal representing a brightness and/or color of an input image portion (e.g., a pixel or other portion of an input image). The system also receives information regarding the characteristics of one or more environmental light rays received in a display region. The characteristics of each environmental light ray include its location, direction, brightness, and/or color. A particular environmental light ray is incident upon, and reflected by, a first portion of the display region, thereby generating a non-directionally reflected light signal. The environmental light ray characteristic information is used to determine the brightness and/or color of the reflected light signal. The brightness and/or color of the reflected light is used to determine how much adjustment should be applied to the first signal (typically, the input signal). The first signal is adjusted accordingly, and the resulting adjusted signal is used to display a corrected image portion in the first portion of the display region.

### BRIEF DESCRIPTION OF THE DRAWINGS

Further objects, features, and advantages of the present invention will become apparent from the following detailed description taken in conjunction with the accompanying figures showing illustrative embodiments of the invention, in which:

FIG. 1 is a flow diagram illustrating an exemplary procedure for displaying images in accordance with the present invention;

FIG. 2 is a flow diagram illustrating an additional exemplary procedure for displaying images in accordance with the present invention;

FIG. 3 is a flow diagram illustrating yet another exemplary procedure for displaying images in accordance with the present invention;

FIG. 4 is a flow diagram illustrating still another exemplary procedure for displaying images in accordance with the present invention;

FIG. 5 is a diagram illustrating an exemplary system for displaying images in accordance with the present invention;

FIG. 6A is a diagram illustrating exemplary two-dimensional content;

FIG. 6B is a diagram illustrating an additional view of the two-dimensional content illustrated in FIG. 6A;

FIG. 7A is a diagram illustrating exemplary “two-dimensional-plus” content;

FIG. 7B is a diagram illustrating an additional view of the two-dimensional-plus content illustrated in FIG. 7A;

FIG. 8A is a diagram illustrating exemplary three-dimensional content;

FIG. 8B is a diagram illustrating an additional view of the three-dimensional content illustrated in FIG. 6A;

FIG. 9 is a diagram illustrating an exemplary system for displaying images in accordance with the present invention;

FIG. 10 is a diagram illustrating an additional exemplary system for displaying images in accordance with the present invention;

FIG. 11 is a diagram illustrating yet another exemplary system for displaying images in accordance with the present invention;

FIG. 12 is a diagram illustrating still another exemplary system for displaying images in accordance with the present invention;

FIG. 13 is a diagram illustrating an exemplary procedure for compressing image data in accordance with the present invention;

FIG. 14 is a diagram illustrating an exemplary method for defining the direction and location of a light ray received by a display region in accordance with the present invention;

FIG. 15A is a diagram illustrating an additional exemplary method for defining the location and direction of a light ray received in a display region in accordance with the present invention;

FIG. 15B is a diagram illustrating yet another exemplary method for defining the location and direction of a light ray received in a display region in accordance with the present invention;

FIG. 16 is a diagram illustrating an exemplary system for detecting environmental lighting in accordance with the present invention;

FIG. 17 is a diagram illustrating another exemplary system for detecting environmental lighting in accordance with the present invention;

FIG. 18 is a diagram illustrating yet another exemplary system for detecting environmental lighting in accordance with the present invention;

FIG. 19 is a diagram illustrating a further exemplary system for detecting environmental lighting in accordance with the present invention;

FIG. 20 is a diagram illustrating an additional exemplary system for detecting environmental lighting in accordance with the present invention;

FIG. 21 is a diagram illustrating still another exemplary system for detecting environmental lighting in accordance with the present invention;

FIG. 22 is a diagram illustrating a still further exemplary system for detecting environmental lighting in accordance with the present invention;

FIG. 23 is a diagram illustrating another additional exemplary system for detecting environmental lighting in accordance with the present invention;

FIG. 24 is a diagram illustrating another further exemplary system for detecting environmental lighting in accordance with the present invention;

FIG. 25 is diagram illustrating yet another exemplary system for detecting environmental lighting in accordance with the present invention;

FIG. 26 is a diagram illustrating yet another further exemplary system for detecting environmental lighting in accordance with the present invention;

FIG. 27 is a diagram illustrating yet another additional exemplary system for detecting environmental lighting in accordance with the present invention;

FIG. 28 is a diagram illustrating still another further exemplary system for detecting environmental lighting in accordance with the present invention;

FIG. 29 is a diagram illustrating yet another exemplary system for detecting environmental lighting in accordance with the present invention;

FIG. 30A is a diagram illustrating an exemplary environmental lighting image generated by a detection system in accordance with the present invention;

FIG. 30B is a diagram illustrating a simplified representation of the image illustrated in FIG. 30A, generated in accordance with the present invention;

FIG. 31A is a diagram illustrating yet another exemplary system for detecting environmental lighting in accordance with the present invention;

FIG. 31B is a diagram illustrating an additional exemplary system for detecting environmental lighting in accordance with the present invention;

FIG. 32 is a diagram illustrating still another further exemplary system for displaying images in accordance with the present invention;

FIG. 33 is a diagram illustrating still another additional exemplary system for displaying images in accordance with the present invention;

FIG. 34 is a diagram illustrating a further additional exemplary system for displaying images in accordance with the present invention;

FIG. 35 is a diagram illustrating a yet further exemplary system for displaying images in accordance with the present invention;

FIG. 36 is a diagram illustrating a still further additional exemplary system for displaying images in accordance with the present invention;

FIG. 37 is a diagram illustrating still another further additional exemplary system for displaying images in accordance with the present invention;

FIG. 38 is a diagram illustrating still another further additional exemplary system for displaying images in accordance with the present invention;

FIG. 39 is a diagram illustrating an exemplary processing system for performing the procedures illustrated in FIGS. 1-4; and

FIG. 40 is a block diagram illustrating an exemplary processing section for use in the processing system illustrated in FIG. 39.

Throughout the figures, unless otherwise stated, the same reference numerals and characters are used to denote like features, elements, components, or portions of the illustrative embodiments. Moreover, while the present invention will now be described in detail with reference to the figures, and in connection with the illustrative embodiments, various changes and modifications to the described embodiments will be apparent to those skilled in the art without departing from the true scope and spirit of the present invention as defined by the appended claims.

### DETAILED DESCRIPTION OF THE INVENTION

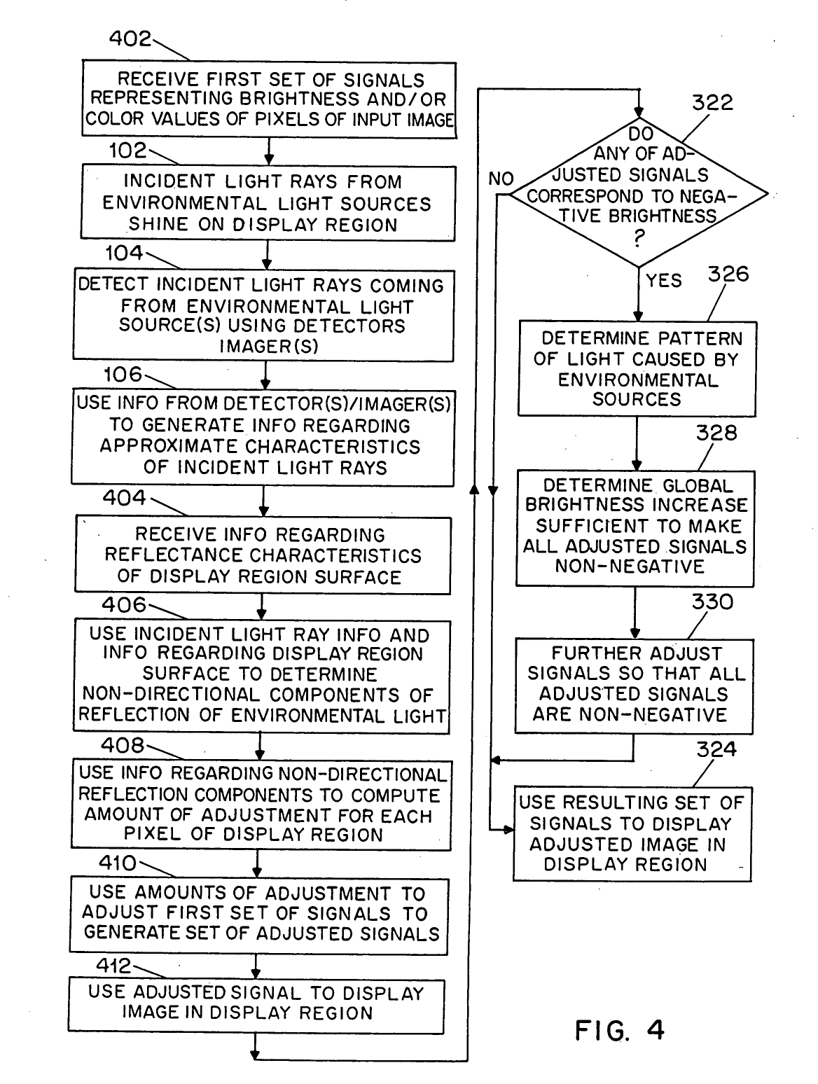

A particular set of lighting conditions exist in any environment in which a display device is being used. In accordance with the present invention, these environmental lighting conditions can be detected and/or modeled in order to adjust the displayed image such that the image as perceived by the viewer(s) more accurately represents the input image originally received by the display device or image displaying system. The flow diagram of FIG. 4 illustrates an example of a procedure which can be used to perform the aforementioned adjustment. In the illustrated procedure, the display system receives a first set of signals representing the respective brightness and/or color values of various portions—typically pixels—of an input image (step 402). Each pixel typically represents a brightness of a portion of the image, a color of the image portion, or a brightness of a particular color component (e.g., red, green, or blue) of the image portion. The display device is configured to display images in a display region which can, for example, be located upon a CRT screen, an LCD screen, or—in the case of projection systems—a wall or projection screen. Light rays from one or more environmental light sources shine on—i.e., are received in—the display region (step 102). The same light rays—or different light rays coming from the environmental light sources(s)—are detected using one or more detectors which can include, for example, one or more imagers (step 104). The detectors can be near or within the display area. For example, the detectors can include a camera mounted on a CRT or LCD display. Alternatively, or in addition, one or more of the detectors can be positioned in a location different from that of the display area. In fact, a wide variety of different types and configurations of detectors can be used to detect the light coming from the environmental light sources. Numerous examples of such detectors and configurations are provided in further detail below.

Regardless of the type and configuration of the detector(s) used to detect the light from the environmental light sources, the information from the detector(s) is used to generate information regarding the characteristics of the incident light rays (step 106). Such information preferably includes information regarding the location, direction, brightness, and/or color of the light rays. For example, a single color camera typically produces an image representing the directions, brightnesses, and colors of incoming rays.

In order to enhance the computational efficiency of the system, the environmental light sources are preferably modeled using the information regarding the characteristics of the incident light rays. The model, examples of which are described below, provides a simplified representation of the environmental lighting field, and therefore enables faster generation of the incident light ray information in step 106.

Preferably, the display system also receives information regarding the reflectance characteristics of the surface of the display region (step 404). The environmental light shines upon the display region surface and produces reflections which have non-directional components and/or directional components. The incident light ray information and the information regarding the display region surface characteristics are used to calculate the brightness and color values of the non-directional reflection components (step 406). In particular, depending upon the extent to which the display area surface is specular or Lambertian, the environmental light is reflected from the display area surface in a directional or non-directional manner. In step 406 of the illustrated procedure, only the characteristics of the non-directionally reflected light are determined. The information regarding the non-directional reflected components is used to compute an amount of adjustment associated with each portion (typically, each pixel) of the display region (step 408). The respective amounts of adjustment are used to adjust the first set of signals, in order to generate a set of adjusted signals (step 410). The adjusted signals are used to display an adjusted image in the display region (step 412).

Under certain environmental lighting conditions, a non-directional reflection component in a particular portion of the display region may have a brightness greater than the intended brightness of the pixel to be displayed in that region. Under such conditions, the adjusted signal used to display the pixel effectively corresponds to negative brightness, and available display systems cannot create “negative” light. Therefore, in order to maintain image quality, it is preferable to globally increase the brightnesses of all of the pixels of the displayed image. The global brightness increase is preferably sufficient to prevent any of the adjusted signals from corresponding to negative brightness. As a result, full contrast is maintained across the entire image. In other words, as illustrated in FIG. 4, if any of the adjusted signals produced by step 412 corresponds to negative brightness (step 322), the procedure determines the pattern of light caused by the environmental sources (step 326), and determines the global increase in brightness required to ensure that none of the adjusted signals correspond to negative brightness—i.e., that no portion of the displayed image appears too bright compared to the other portions of the displayed image (step 328). The adjusted signals are then further adjusted according to the global brightness increase determined in step 328 (step 330). The resulting set of signals is then used to display an adjusted image in the display region (step 324). If, on the other hand, none of the adjusted signals from step 412 corresponds to negative brightness (step 322), then the adjusted signals from step 412 are used to display the adjusted image in the display region (step 324).

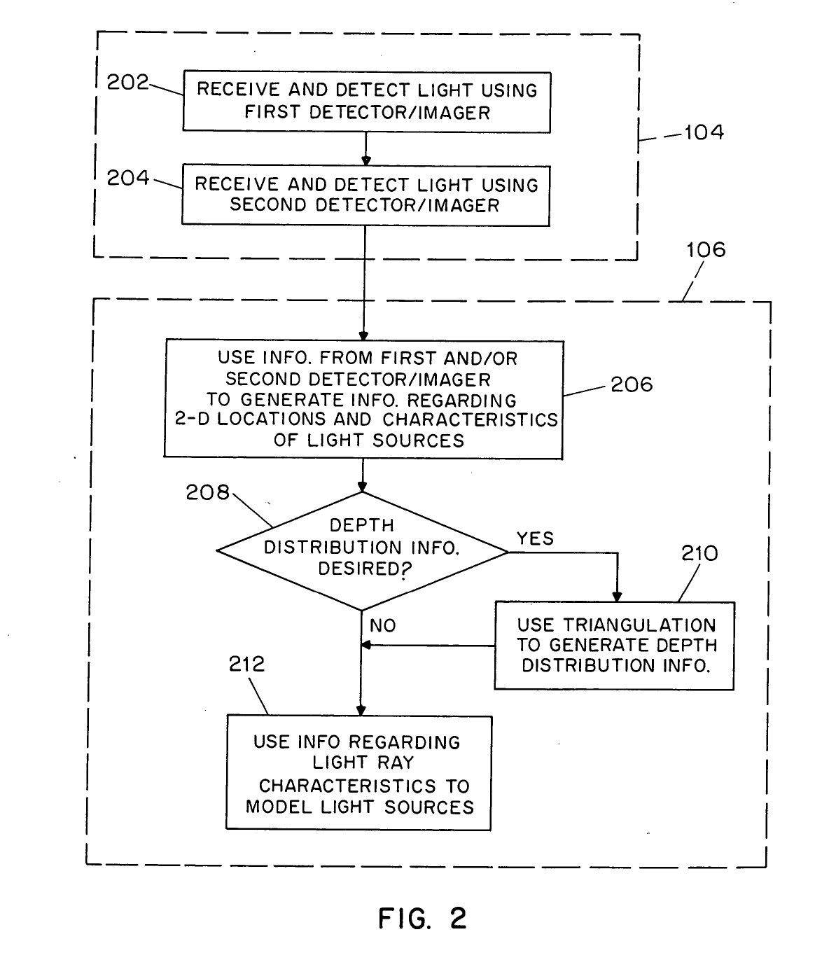

FIG. 2 illustrates an exemplary procedure for generating information regarding the characteristics of incident light rays. In the illustrated procedure, the step of detecting the environmental light (corresponding to step 104 of FIG. 4) includes receiving and detecting the environmental light using first and second detectors—e.g., imagers (steps 202 and 204). The information from the detectors is used to generate the light ray characteristic information (step 106) by using the information from the first and/or second detector(s) to generate information regarding the two-dimensional, directional locations of the environmental light sources—i.e., the vertical and horizontal angle of each source in the field of view of one or both detectors/imagers (step 206). As an additional part of step 206, the detectors/imagers measure the brightness and color of each light source. If light source depth—i.e., distance—information is desired (step 208), the information from the two imagers is used to perform a triangulation technique which compares the data from the first and second detectors in order to generate the depth information (step 210). As discussed above with respect to the image adjustment procedure illustrated in FIG. 4, the computational efficiency of the system can be enhanced by using the information regarding the incident light rays to model the environmental light source(s) (step 212).

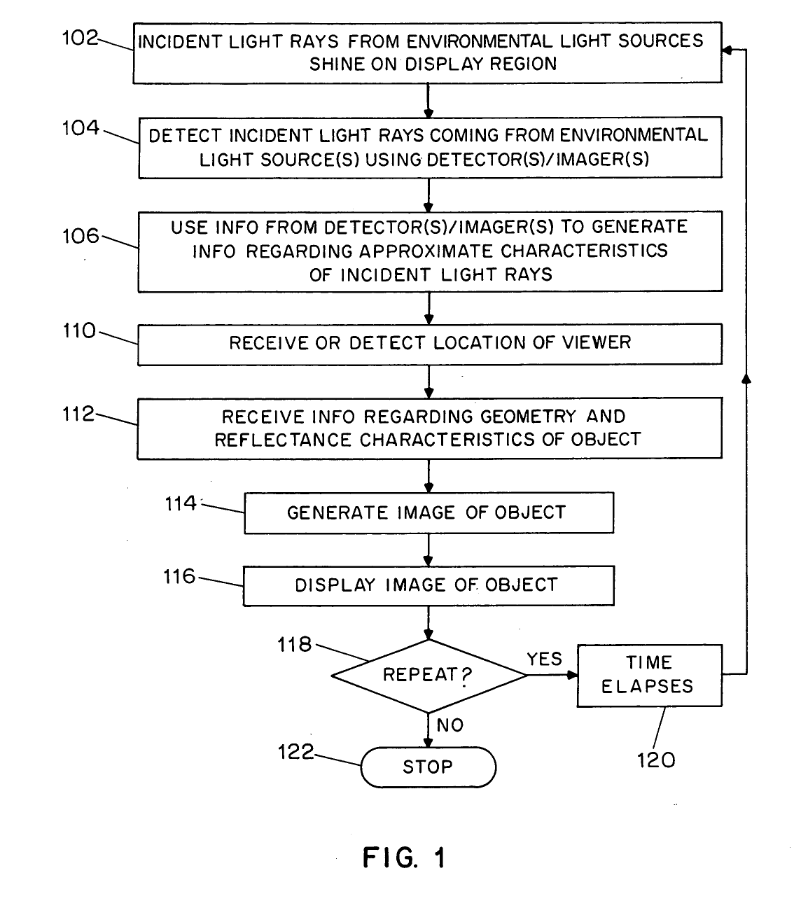

Information regarding the environmental light received in the display region can also be used to simulate the appearance of an object as if illuminated by the environmental light. It is to be noted that the term “object” as used herein is not intended to be limiting, and is meant to include any item that can be displayed, including smaller, movable items (e.g., small paintings and sculptures) as well as larger features of any scene, such as mountains, lakes, and even astronomical bodies. Objects can be portrayed in two dimensions (2-d), two dimensions with raised features and texture (2-d+), or three dimensions (3-d). An example of a procedure for performing such rendering is illustrated by the flow diagram of FIG. 1. In the illustrated procedure, incident light rays from one or more environmental light sources shine on—i.e., are received in—a display region which can be, for example, the display area of a CRT or LCD screen (step 102). The incident light rays coming from the environmental light source(s) is detected using one or more detectors which can include, for example, one or more imagers (step 104). The detection of the light from the environmental light sources can be performed using a wide variety of techniques. Typically, it is preferable to detect and/or calculate the brightness and direction of light striking various portions (e.g., pixel regions) of the display region. Numerous techniques for detecting the brightness and/or direction of environmental light are described in further detail below.

The information from the detectors is used to generate information regarding the characteristics of the light rays incident upon the display region (step 106). Preferably, the generated information includes information regarding the location, direction, brightness, and/or color of each incident ray light. Preferably, the location of the viewer of the display is either detected directly—e.g., using a camera—or otherwise received (step 110). Viewer location is relevant for rendering objects which appear different depending upon the angle from which they are viewed. For example, 3-d content is most accurately rendered if the viewer's position is known. The system receives additional information regarding the geometry and reflectance characteristics of the object being displayed (step 112). Using the information regarding the incident light rays, and the information regarding the geometrical and reflectance characteristics of the object, an image of the object is generated (step 114) and displayed in the display region (step 116). Optionally, the displayed image can be updated in real time as the environmental lighting conditions change. If such updating is desired (step 118), a selected amount of time is permitted to elapse (step 120), and the procedure is repeated by returning to step 102. If no updating is desired (step 118), the procedure is terminated (step 122).

Environmental light fields can be measured and/or approximated using a variety of different types of illumination sensing devices. For example, as discussed in further detail below, the environmental light field can be sensed by a photodetector, an array of photodetectors, one or more cameras, or other imagers, and/or one or more fiber optic bundles.

In a rendering procedure in accordance with the present invention, the measurements from one or more environmental light field detectors are used to render an image of input content as if the content (e.g., a set of scene objects) were illuminated under the lighting conditions present in the room in which the image is being displayed. The rendering algorithm utilizes a computer graphics model of the content being rendered, as well as information regarding illumination field, to perform the rendering operation. The content and the illumination field are not necessarily static, but can change with time. In cases of changing input content and/or lighting, the displayed image is preferably updated repeatedly at a rate sufficiently rapid to generate a movie or video sequence in the display region.

The computer graphics model of the input content can have both virtual and “environmental” components. The virtual components include graphics models of the object(s) to be rendered. Such objects can include, for example, photographs, paintings, sculpture, animation, and 3-d video. The environmental component of the content includes models of objects in the room of the display device. Such objects can include, for example, the display device, the frame in which the display device resides, and other objects and architectural details in the room. The environmental models are used to simulate illumination effects—e.g., shadowing and interreflection—that the environmental objects would have upon the virtual object(s) being rendered, if the virtual objects were actually present in the room.

Similarly to the input content, the illumination field can also include both virtual and environmental components. The virtual component of the light field can include the virtual light sources used to illuminate the content. The environmental illumination field is the field actually measured by illumination field detectors.

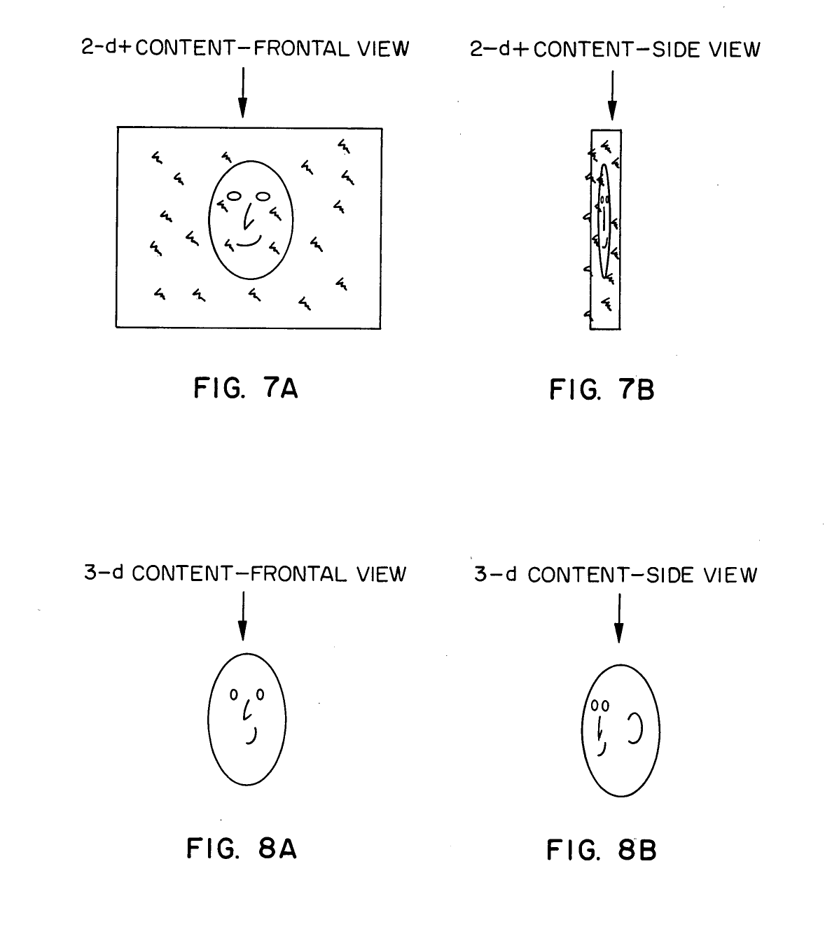

The content typically includes one or more of three basic forms: 2-d, 2-d+, and 3-d. 2-d content typically represents a flat object such as a drawing, photograph, two-dimensional image, video frame, or movie frame, as illustrated in FIGS. 6A and 6B. 2-d+ content represents a nearly flat, but bumpy object, such as a painting, as illustrated in FIGS. 7A and 7B. 2-d+ content can be expressed as a graph of a height function in two dimensions. 3-d content represents full 3-d objects such as sculptures, three-dimensional CAD models, and/or three-dimensional physical objects, as illustrated in FIGS. 8A and 8B. The shape of a 3-d scene or object can be acquired using a measuring system such as, for example: (1) a laser range finder which provides information regarding scene structure, (2) a binocular stereo vision system, (3) a motion vision system, or (4) a photometric-based shape estimation system.

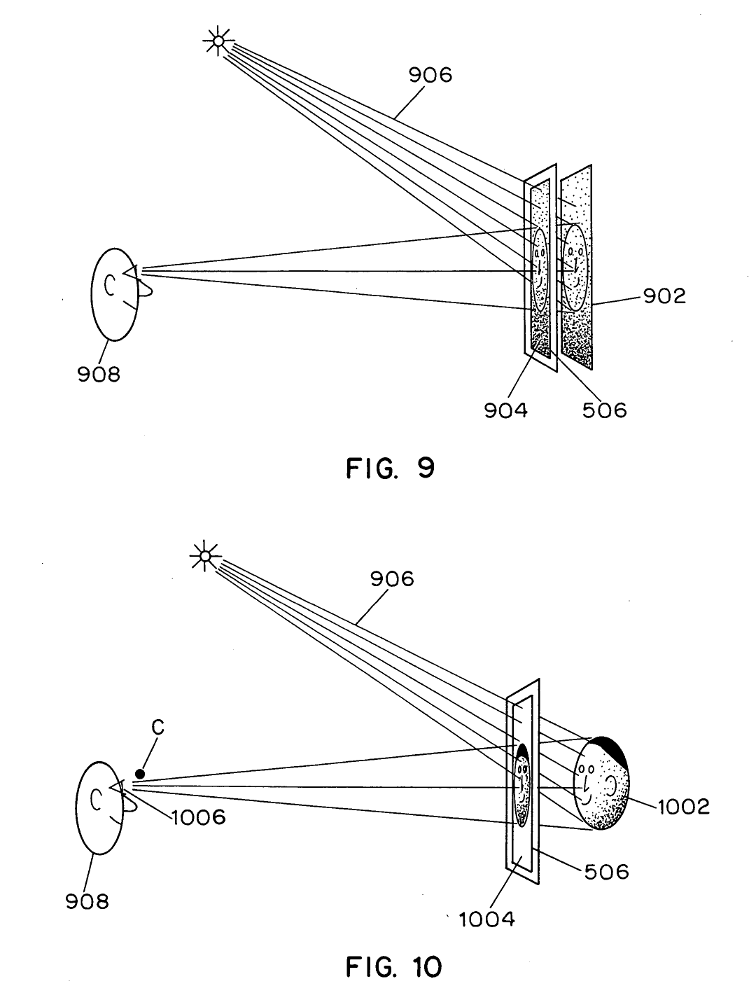

As illustrated in FIG. 9, in the case of 2-d and/or 2-d+ input content 902, the displayed image 904 represents the simulated content as if oriented and positioned to be in the plane of the display region 506. The content is presented to the viewer 908 as if illuminated by the environmental illumination 906.

As illustrated in FIG. 10, in the 3-d case, the 3-d input content 1002 is simulated so that it appears to be behind the display region 506. A viewpoint c in front of the display device is specified, and the content 1002 is rendered to form an image 1004 which represents the content 1002 as if the content 1002 is being viewed from the viewpoint c. Preferably, the viewer 908 is positioned such that his/her eye(s) 1006 are as close as possible to the viewpoint c. The plane of the display region 506 is treated as virtual window pane through which the content is viewed.

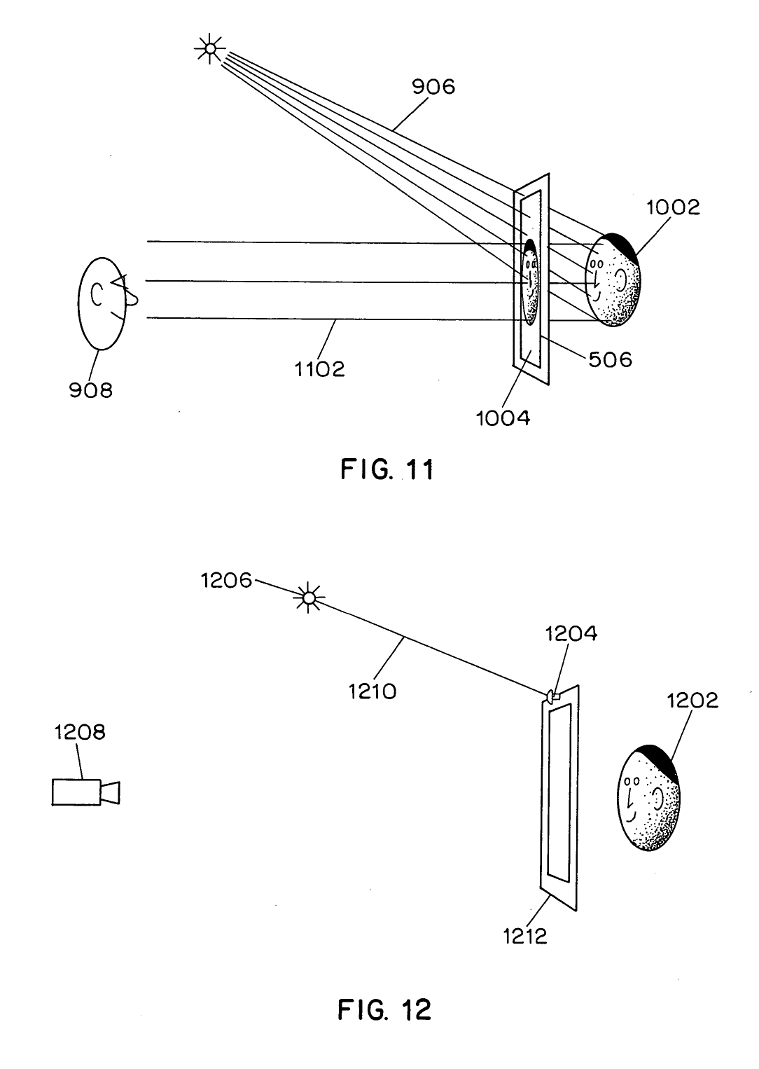

Because the content is specified by a computer graphics model, the content has no actual 3-d position, orientation, and viewpoint. Rather, the position, orientation, and viewpoint are virtual quantities chosen relative to a coordinate system referenced to the location of the display device. Moreover, there is great flexibility with respect to the choice of these virtual quantities. For example, if it is desirable to provide wide angle rendering of the content with strong perspective effects, the viewpoint is preferably specified to be close to the display plane. On the other hand, as illustrated in FIG. 11, if narrow-angle, or near orthographic, rendering of the content is desired, the viewpoint is preferably specified to be at a great distance—perhaps even an infinite distance—from the display device. In the case of an infinitely distant viewpoint, the content is rendered as if viewed along a set 1102 of orthographic lines of sight.

Although the viewpoint c in the above examples is pre-selected, the viewpoint c can also be treated as a control parameter which can vary with time. For example, in many cases the viewer 908 is non-stationary with respect to the display region. In such cases, a variety of measurement techniques can be employed to estimate the viewpoint c. For example, conventional “people-detection” and face-recognition software can be used to locate the viewer 908 and/or his/her eyes 1006 in three-dimensional space. There are also several well-known “gaze” detectors capable of tracking the eyes of a person. Alternatively, or in addition, an active or passive indicating device can be affixed to the viewer 908 in order to enable the display device to track the location of the viewer 908 (or his/her head) in real time. In any case, the lighting sensitive display system can use the aforementioned measurements to determine the viewpoint c. Knowledge of the viewpoint c enables the rendering algorithm to incorporate viewpoint-sensitive effects into the displayed image. For example, as the viewer 908 walks around a wall-hanging digital art display, the geometry and the photometry of the objects being displayed can be updated in order to make the displayed objects appear both three-dimensional and realistic in their reflectance properties.

The input content is preferably pre-specified according to a computer graphics model. 2-d content is typically modeled as a planar rectangle which has a spatially varying bidirectional reflectance distribution function (BRDF). 2-d+ content is typically modeled as a planar rectangle having an associated “bump map”, i.e., a map of height or depth as a function of location within the rectangle. Alternatively, or in addition, 2-d+ content can be modeled as a graph of a 2-d function. Similarly to 2-d content, 2-d+ content can have a spatially varying BRDF. 3-d content is typically modeled according to one or more of a variety of computer graphics formats. Such computer graphics models are typically based on polygonal facets, intersecting spheres or ellipses, splines, or algebraic surfaces. In some cases, the BRDF of the 2-d, 2-d+, and 3-d content is homogeneous, and in other cases, the BRDF is spatially varying. The BRDF can be modeled according to any of a number of well-known models, including parametric models (e.g., Lambertian, Phong, Oren-Nayar, or Cook-Torrance), and/or phenomenological models (e.g., Magda or Debevec).

The environmental light field measured by the illumination sensing device(s) is processed and provided as input to the rendering algorithm. The rendering algorithm uses the light field information to render an image of the object's appearance as if the object were illuminated by the environmental illumination of the room in which the display resides. In addition to the actual, detected illumination field, the system can optionally add a pre-specified virtual lighting component.

The image rendering is performed repeatedly each time the displayed image is updated. Preferably, the image is updated at a rate equal to or greater than 24 frames/second so that the rendering appears continuous to the viewer.

The above-described rendering method uses well-known computer graphics models to render virtual objects and/or scenes using assumptions regarding the geometrical and optical characteristics of the objects and/or scenes. Alternatively, or in addition, a rendering algorithm in accordance with the present invention can use actual (preferably digital) images of a scene or object taken under a variety of lighting conditions. The rendering process can be considered to include three stages: data acquisition, data representation, and real-time rendering.

In the data acquisition stage, the scene or object is preferably illuminated by a single point light source (e.g., an incandescent, fluorescent, or halogen bulb) located at a fixed distance from the scene, as is illustrated in FIG. 12. An image of the scene 1202 is acquired using a digital camera or camcorder 1208 (a/k/a the “scene camera”) focused on the scene 1202. An image of the light source 1206 illuminating the scene 1202 is acquired using a wide-angle camera 1204 (a/k/a the “light source camera”) placed adjacent to the scene and facing toward the area of space in front of a reference plane 1212. While both the scene camera 1208 and the light source camera 1204 remain fixed, the light source 1206 is moved, and the process is repeated up to several hundred times, or more, depending on the number of light source directions for which data is desired. Acquiring data for a larger number of light source directions—i.e., finer sampling of light source directions—tends to provide more accurate rendering during the real-time rendering stage. For each repetition of the data acquisition procedure, an image of the scene 1202 and an image of the light source 1206 are acquired. The various positions of the light source 1206 are selected so as to thoroughly sample the set of lighting directions in front of the reference plane 1212. Optionally, a physical tether 1210 can be used to maintain the light source at an approximately fixed distance from the light source camera 1204. The scene images are stored to form a “scene image data set” for later use. Similarly, all of the light source images are stored to form a “light source image data set” for later use. Each stored scene image is associated with the particular light source image which was captured at the same time that the scene image was captured.

After the scene images and the light source images are acquired, the images are processed in the data representation stage. The light source images are processed in order to determine the center position of the light source in each image. This procedure can be performed using the full resolution of the light source images, or if increased speed is desired, can be performed using a reduced resolution. For each image, the center of the light source is preferably located by finding the location of the brightest pixel in the light source image.

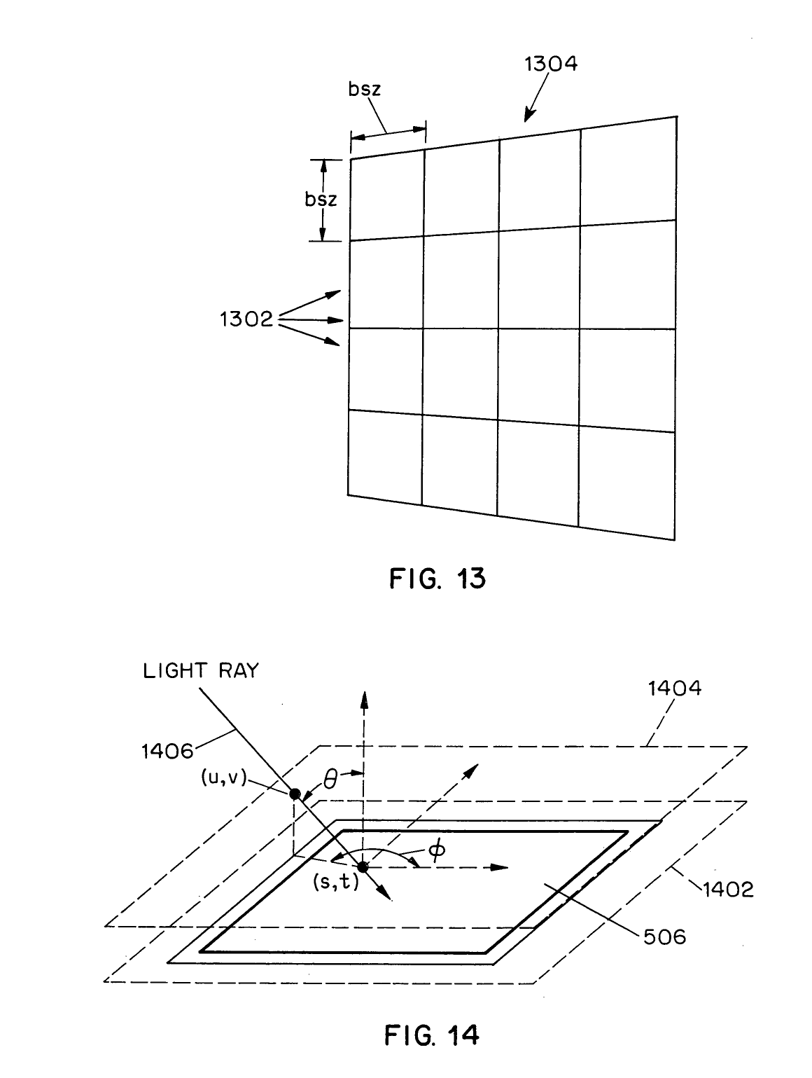

Each scene image is processed to generate data which has a reduced total storage size and is simpler to render. As illustrated in FIG. 13, the scene image 1304 is first divided up into sub-images 1302 (a/k/a “blocks”) each having a size of bsz×bsz pixels. The chosen block size bsz can be, for example, 16 pixels, or can be smaller or larger, depending upon the desired compression of the data and the desired image quality. Larger block sizes tend to provide enhanced computational efficiency by increasing the amount of compression, but also tend to decrease the quality of the rendering. Smaller block sizes tend to decrease the amount of compression, but tend to increase the quality of the rendering.

The compression procedure can, for example, treat the block in the upper left corner of a scene image as the “1st block.” Each scene image in the scene image data set thus has a first block. Each of the first blocks is “vectorized”—i.e., formed into a vector of length bsz×bsz—by stacking the columns of pixels in the block, one on top of the other. Each of the vectors is then added, as a matrix column, to a matrix called the “1st block matrix.” If numins is the total number of scene images, then the 1st block matrix has bsz×bsz rows and numins columns. Singular value decomposition is performed on this matrix, and the resulting blkdim eigenvectors corresponding to the largest blkdim eigenvalues (where blkdim<<numins and blkdim<<bsz×bsz) are stored. All remaining eigenvalues are discarded. Each eigenvector has a length bsz×bsz, and therefore, the collection of blkdim eigenvectors can be stored in a matrix having bsz×bsz rows and blkdim columns. An exemplary choice of blkdim is 10. If more eigenvalues are kept, the quality of the rendering increases, and if fewer eigenvalues are kept, the quality of the rendering decreases. The above-described process is repeated for all blocks in the scene image data set, and the resulting eigenvectors for the block are stored in a matrix PC.

The algorithm also computes the coefficient vectors needed to approximate the images in the scene image data set, by calculating linear combinations of the saved eigenvectors within the matrix PC. The computation of the linear combinations is performed by receiving each image, dividing the image into blocks, and computing the inner product of each image block with its corresponding set of PC eigenvectors in order to generate an approximation coefficient vector for that block. A single approximation coefficient vector specifies a set of weights which are applied to the linear combination of eigenvectors associated with a particular block within the image. The values of the approximation coefficients are dependent upon the particular light source image being processed. Each coefficient vector has blkdim coefficients for each block of the image. The coefficient vectors for all of the numims images in the scene image database are stored in a matrix “ccs.” Note that the matrix PC of eigenvectors and the matrix ccs of coefficient vectors contain information sufficient to regenerate all of the images in the scene image data set. In order to further compress the scene image data set, a second singular value decomposition is performed on the matrix of coefficient vectors ccs. Only the eigenvectors corresponding to the largest coefdim eigenvalues are kept and stored in a matrix PCc.

After the coefficient vectors have been compressed, the algorithm determines a set of coefficients needed to generate an image associated with any one of the light source positions. This procedure is performed by: (1) receiving each image, (2) dividing the image into blocks, (3) computing the inner products of the image blocks and the corresponding PC eigenvectors in order to produce a second stage coefficient vector, (4) taking the inner product of the second stage coefficient vector and each of the PCc eigenvectors, and (5) storing the resulting coefdim second stage coefficients in a 3-dimensional matrix. This process is performed for each lighting direction and for each color channel, thereby generating three 3-dimensional matrices rmapXr, rmapXg, and rmapXb. The matrices PC, PCc, rmapXr, rmapXg, and rmapXb now contain data sufficient to generate a scene image. These matrices not only conserve storage space by a factor of 200-500, but also enable real-time rendering of the scene under essentially any combination of any number of point light sources or other types of sources.

In the real-time rendering stage, a lighting monitoring camera is used to acquire measurements of the environmental illumination. The lighting monitoring camera preferably has characteristics similar to those of the camera used to acquire the light source database. In addition, with respect to the reference plane (item 1212 in FIG. 12), the location of the monitoring camera with respect to the display region is preferably similar to the location of the light source database acquisition camera. If the two cameras have different characteristics and/or locations, the system performs a simple calibration step in order to map the cameras' respective characteristics and/or fields of view to each other.

Each measured lighting image received by the system during the rendering stage includes three color channels, each channel being represented by a corresponding matrix: illumr, illumg, or illumb for the red, green and blue channels, respectively. Each element of each of these matrices is multiplied by the corresponding element of each of the coefdim layers of the corresponding matrix rmapXr, rnapXg, or rmapXb. The resulting products are then added together for each color channel separately. This results in three coefficient vectors of length coefdim. These coefficients are then used as weights for the above-described linear combinations of the PCc eigenvectors, which are in turn used as weights for the above-described linear combinations of the PC eigenvectors. This final linear combination produces an image of the scene as if it had been illuminated by the lighting measured by the monitoring camera. The image is then displayed in the display region. The rendering procedure is iteratively repeated: as each frame from the monitoring camera is acquired, a new display image is computed and displayed.

The input models used in the system preferably include models for the geometry and reflectance of objects, as well as the environmental lighting. The various components of the input are combined into a unified collection of lighting models and geometric models. User preferences determine which type of rendering is applied and which of the compensation algorithms discussed above are applied.

Although a wide variety of lighting models can be used, the techniques of the present invention can be readily understood with reference to the simple case of a set of point light sources supplemented by an overall ambient component. The model is preferably computed in real time from images captured by the camera. The model works quite effectively using the color and locations of point light sources, and this information can be computed from a relatively low resolution—e.g., 64×64 pixel—image. The viewing direction associated with each pixel can be computed using a calibration procedure based upon a geometrical grid which defines a set of regions in front of the sensor. Each of the pixels in the grid can be associated with a light source intensity and direction. Typically, approximately 256 grid regions, each corresponding to a particular light source direction, are used. However, the present invention can also use fewer regions or more regions. A pixel corresponding to the direction of a bright light source will have a large brightness value. Extended physical light sources such as the sky typically yield large brightness measurements in a large number of directions—i.e., for a large number of grid regions.

For simpler rendering models, the algorithm can be configured to use only the N most significant light sources, where N is preferably the largest number of point sources that can be rendered efficiently by the chosen model. For selecting which N locations are to be considered light sources, the procedure can optionally use a brightness threshold to select potential light source locations. The initial selection step can optionally be followed by a non-maximal suppression and/or region-thinning procedure which locates the best point in each potential cluster of values. A preferred method is to use a system which adapts the camera shutter rate such that only pixels having brightnesses above a selected threshold are detected. Such a technique provides highly accurate localization and intensity measurements. If certain light source pixels are “saturated” (i.e., at or above the maximum measurable intensity), then the magnitude and color of the ambient lighting can be computed by considering the brightness/color of adjacent points, and/or other points which are not direct light sources. If indirect light sources are present, and if scene objects are expected to be strongly colored, it is preferable to assume that the indirect sources are white and to estimate only the magnitudes of the sources.

The environmental lighting model can be combined with additional lighting models provided by the manufacturer of the display device and the provider of the content, in order to provide a combined lighting model which includes a list of point light sources plus the magnitude and color of the ambient lighting.

Using one or more of the above-described lighting models, and a full 3-d geometrical model of the content, a conventional rendering software package is employed to render the content. A hardware-based accelerator such as a graphics processor—commonly available in many desktop and laptop computers—is preferably used to provide enhanced graphics processing speed.

The system can be configured to permit direct user control of 3-d objects displayed in the display region. For example, the user can be allowed to change the position and/or orientation of an object, or to instruct the system to cause the object to rotate as the lighting model is updated in real time. Simultaneously with the adjustment of the 3-d content, the system preferably adjusts the image in accordance with changes in the local environmental lighting conditions.

For purely 2-d content, the system need not use a 3-d software package. Rather, it is sufficient to use the overall lighting and the BDRF pattern of the content for determining the desired brightness for each pixel of the displayed image. For each color channel of each pixel of the content, the computation of desired brightness is the sum, over all relevant light sources, of the source magnitude multiplied by the BRDF, wherein the BRDF of each content pixel is indexed according to the angle of each light source with respect to the content pixel. Frame shadowing effects can be included using a visibility calculation procedure which pre-computes shadows based upon frame and content geometry. One technique for simulated shadow casting is to compute a lookup table indicating which light sources shine light on each content pixel. A light source not shining on the pixel is not included in the calculation of the brightness of the corresponding displayed pixel. As light sources change positions, the table is updated. For environments containing rapidly moving light sources, it is preferable to pre-compute the shadows.

The 2-d+ rendering the process is very similar to that of the 2-d process except that, in accordance with standard graphics techniques for bump-mapping, a bump map of the 2-d+ representation is applied in order to perturb the surface normal vector before indexing the BRDF of each content pixel according to the angle of each light source. The remaining steps are preferably identical to those of the 2-d rendering procedure. If increased speed is desired, the algorithm preferably neglects changes in shadowing caused by the bump map.

An additional enhancement of the 2-d and 2-d+ techniques is to render them as discussed above, and then to use a conventional graphics package to simulate a display frame shadow which is included in the displayed image.

For applications in which speed is particularly important, the system preferably uses the original brightness value of each content pixel, the surface normal direction associated with the pixel, and the spatial location of the pixel as indices to determine the output value associated with the pixel.

Alternatively, or in addition, to LUT based implementations, field-programmable gate arrays or custom ASICs can be used to directly compute the rendered and/or compensated values. Such hardware-based computation techniques are typically faster than LUTs, although they tend to be more expensive.

In accordance with an additional aspect of the present invention, the above-described, content-rendering procedure can be combined with the above-described technique of using environmental lighting information to correct for errors in the displayed image. For example, once a rendered image of the input content is computed, a correction can be applied in order to compensate for non-directional reflections of light coming from the environmental light sources, as discussed in further detail above with respect to the image adjustment procedure.

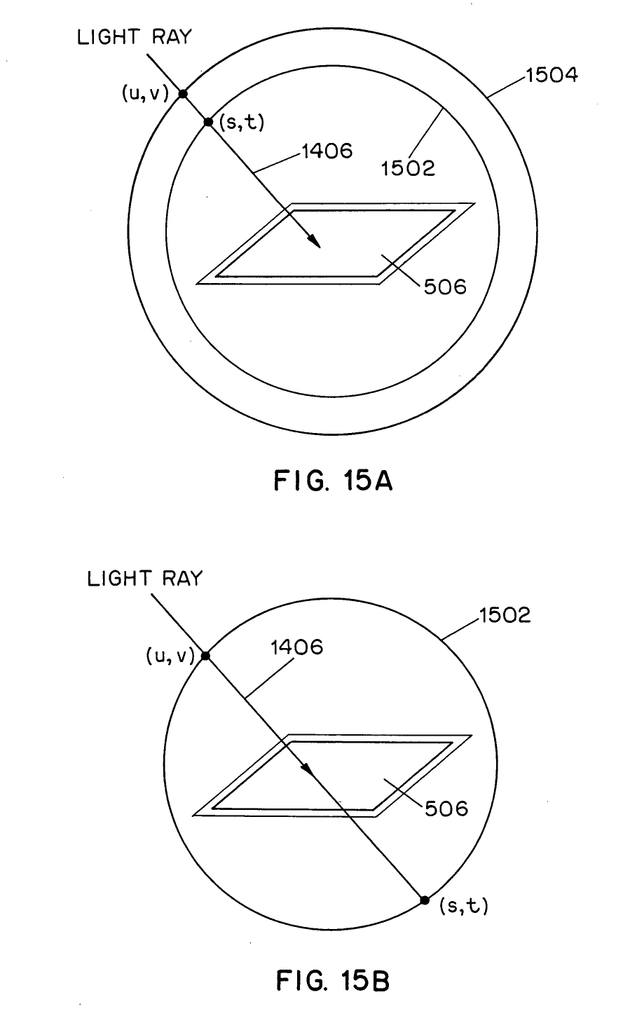

In accordance with the present invention, there are numerous techniques that can be used to sense the environmental illumination field (a/k/a the lighting field) in the environment of the display region. The environmental illumination field which is to be measured can be considered to include not only the total illumination energy incident at a point in the display region, but the characteristics of the complete set of light rays received in the display region. The characteristics of each incident light ray can include, for example, location, direction, brightness, spectral distribution, and polarization. A complete description of the illumination field at a particular point of the display region generally includes information regarding the characteristics of the incident light, as a function of direction. For a flat display region such as the display region 506 illustrated in FIG. 14, a convenient representation of the illumination field can be based upon a pair of parallel planes 1402 ands 1404. A pair of points (s,t) and (u,v) selected from the first and second planes 1402 and 1404, respectively, defines the direction and position, in three-dimensional space, of a ray 1406 of incoming illumination. The illumination field can thus be described as a set of illumination characteristics (e.g., intensity and/or color) parameterized with respect to pairs of points lying on the two planes. It is to be noted that the above-described representation based upon a pair of planes is only one example of such a parametric representation. An additional example, illustrated in FIG. 15A, is a representation based upon a pair of concentric spheres 1502 and 1504 having different radii. The parameters (s,t) and (u,v) are then points on the two spheres. Alternatively, or in addition, as is illustrated in FIG. 15B, a single sphere 1502 may be used, in which case (s,t) and (u,v) are any two points on the sphere, and the chord connecting them corresponds to the ray 1406 of interest.

There is more than one valid way to represent the incident illumination brightness along any given ray direction. For example, the brightness can be represented by the radiance L(s,t,u,v, λ) of the environment as seen along a ray (s,t,u,v) intersecting a point in the display region. The ray extends to either a direct light source or an indirect light source such as a reflecting surface in the scene.

An additional possible way to represent illumination intensity is by computing the irradiance E(s,t,u,v, λ), which is the amount of flux per unit area falling on the display due to the radiance L(s,t,u,v, λ). If the display lies on one of two planes such as the planes 1402 and 1404 illustrated in FIG. 14, the parameters (s,t) determine locations on the display, and the parameters (u,v) represent directions. Alternatively, or in addition, the angular parameters (θ,φ) can be used to define ray direction in spherical coordinates, where θ is the polar angle of the ray and φ is the azimuth angle of the ray, as illustrated in FIG. 14.

L and E are typically functions of the wavelength λ of light. This wavelength dependence can be measured in a number of ways. For example, if many narrow-band detectors are used to detect the illumination field, then the entire spectrum of L can be measured. In contrast, a panchromatic detector or detector array typically provides a single gray level value for each point of interest. If three sets of spectral filters (e.g., red, green, and blue) are used in conjunction with a panchromatic detector or array, the usual R, G, and B color measurements are obtained. For brevity of notation, the following explanation is provided with respect to a single wavelength. However, this is not meant to imply that the analysis or the present invention is in any way restricted to a single wavelength; the results apply to any and all wavelengths and/or combinations thereof.

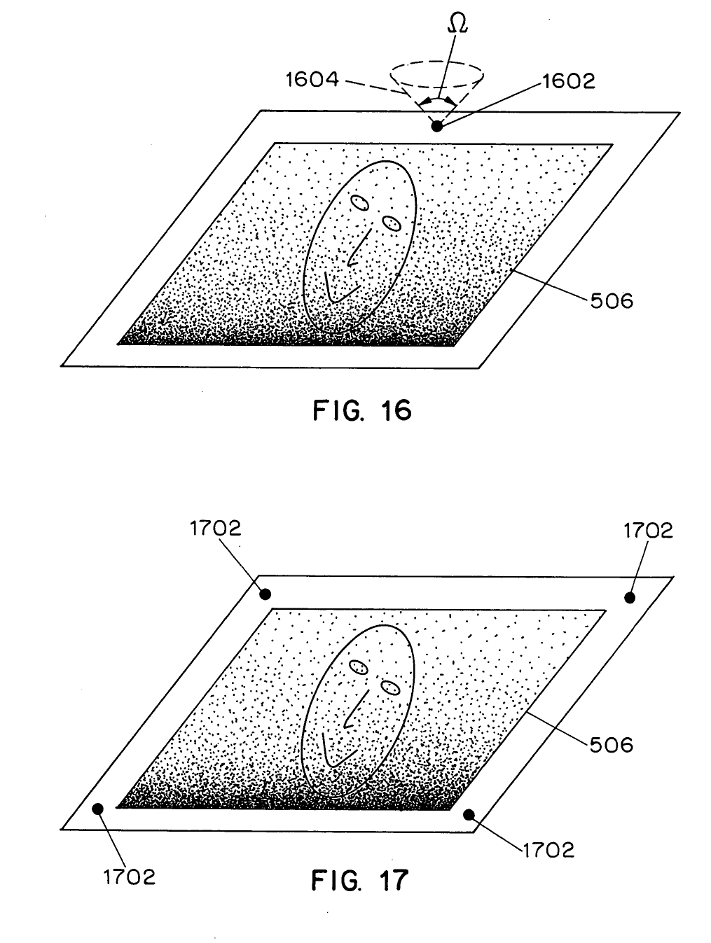

An example of a simple method for measuring environmental illumination, illustrated in FIG. 16, uses a single photodetector 1602. The photodetector 1602 measures the average brightness of the environmental illumination—i.e., incoming light signals—within the detector's cone of sensitivity 1604. If the cone of sensitivity 1604 has a solid angle Ω, then the total irradiance measured by the photodetector is:

Ê=∫₁₀₆ ∫w(θ,φ)E(θ,φ)sin θdθdφ (1)

where w(θ,φ) represents the directional sensitivity of the photodetector. This measurement of total irradiance approximately indicates the overall brightness of the environment as seen by the photodetector, and does not by itself provide dense spatial and directional sampling of the illumination field.

If the cone of sensitivity of the photodetector encompasses the entire volume in front of the detector, and w(θ,φ)=1 within the hemisphere, then the measured irradiance Ê represents the total irradiance incident on the display at the location of the photodetector. If such a measurement can be made at every point on the display, the measurements provide the illumination energy field Ê(s,t) which does not include the angular (i.e., directional) characteristics of the environmental light sources, and is therefore different from the illumination field E(s,t,u,v) which includes angular characteristics.

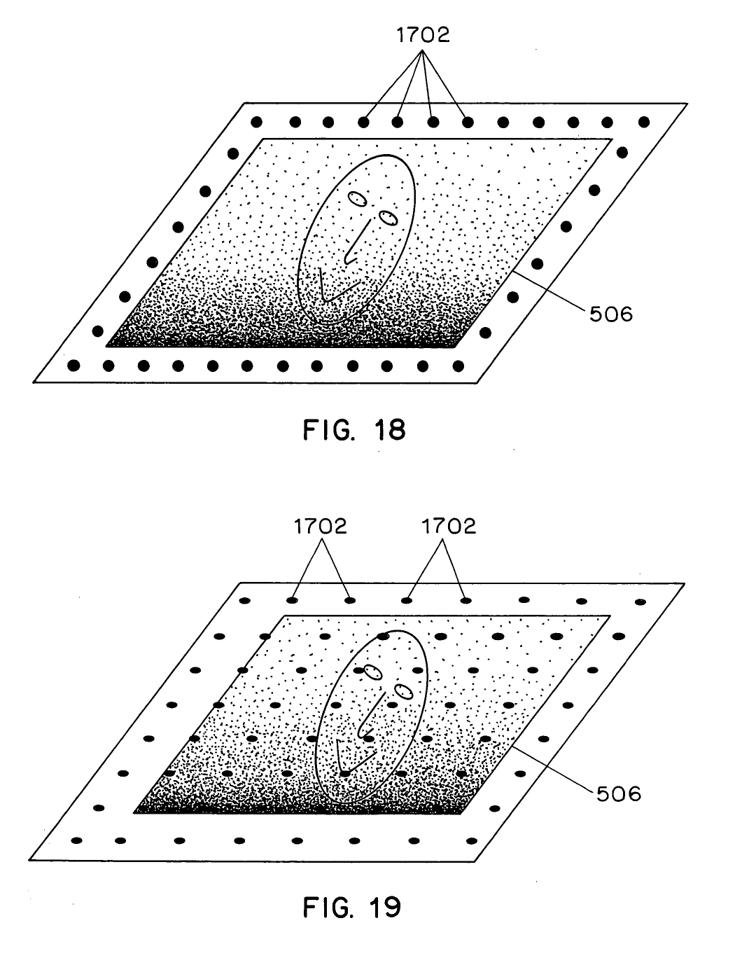

There are numerous ways to measure the illumination field and the illumination energy field in accordance with the present invention. For example, FIG. 17 illustrates a display having four photo-detectors 1702, one in each corner. The resulting four energy measurements can be interpolated—e.g., using linear or bilinear interpolation—in order to compute an energy estimate for any point in the display region 506. A multi-detector approach for computing the illumination energy field can also employ other arrangements of photosensitive detectors. For example, as illustrated in FIG. 18, many detectors 1702 can be positioned around the periphery of the display region 506. Even more complete coverage, and hence greater accuracy of the field measurement, can be obtained using a two-dimensional array of detectors 1702 such as the array illustrated in FIG. 19. Such an array can be realized by embedding equally-spaced or unequally-spaced photo-detectors 1702 within the physical structure of the display device—for example, the detectors 1702 can be formed lithographically as part of the circuit forming an LCD. Alternatively, or in addition, detectors can be placed on the top surface of the display region. In any case, because solid-state detectors can be made very small (e.g., several microns in size), such an array does not cause a great reduction of the visual resolution of the display itself. In addition, the display device can be fabricated such that it includes a detector located adjacent to each display element. If the distribution of the detectors is sufficiently dense, the continuous illumination energy field can be computed from the discrete samples using a variety of interpolation techniques. Such techniques can include, for example, bilinear interpolation, sinc interpolation, and bicubic interpolation, all of which are well known methods for reconstructing continuous signals from discrete samples.

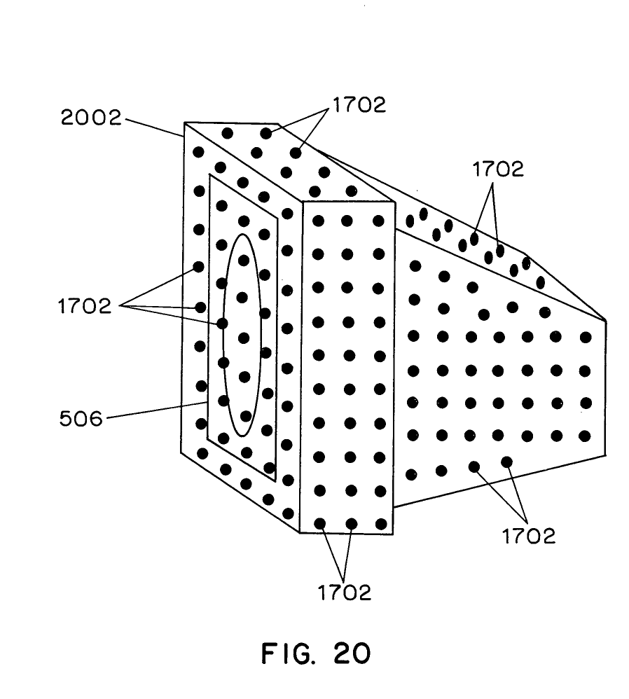

In some cases, the relevant illumination energy field extends well beyond the dimensions of the display region 506. FIG. 20 illustrates an exemplary arrangement for detecting such a field. In the illustrated example, photo-detectors 1702 are distributed all over the surfaces of a display device 2002, including the back and sides. The illustrated display device 2002 is a computer monitor or a television. Such a detector arrangement is particularly advantageous in cases in which the relevant lighting includes not only the illumination incident on the display region 506, but also the illumination behind the display region. Illumination behind the display region 506 can be important because the appearance of visual content to a human observer often depends upon the background lighting conditions. A very dark background tends to make the displayed content appear brighter, even disconcerting in some cases. On the other hand, a very bright background can cause the content to appear dim and difficult to perceive. Therefore, measurements of the light behind the display can be used to adjust the visual content in order to make the content more easy to perceive. In addition, for content rendering/simulation applications, information regarding the illumination behind the display region can be used to render the content in a manner more consistent with the entire environmental illumination field.

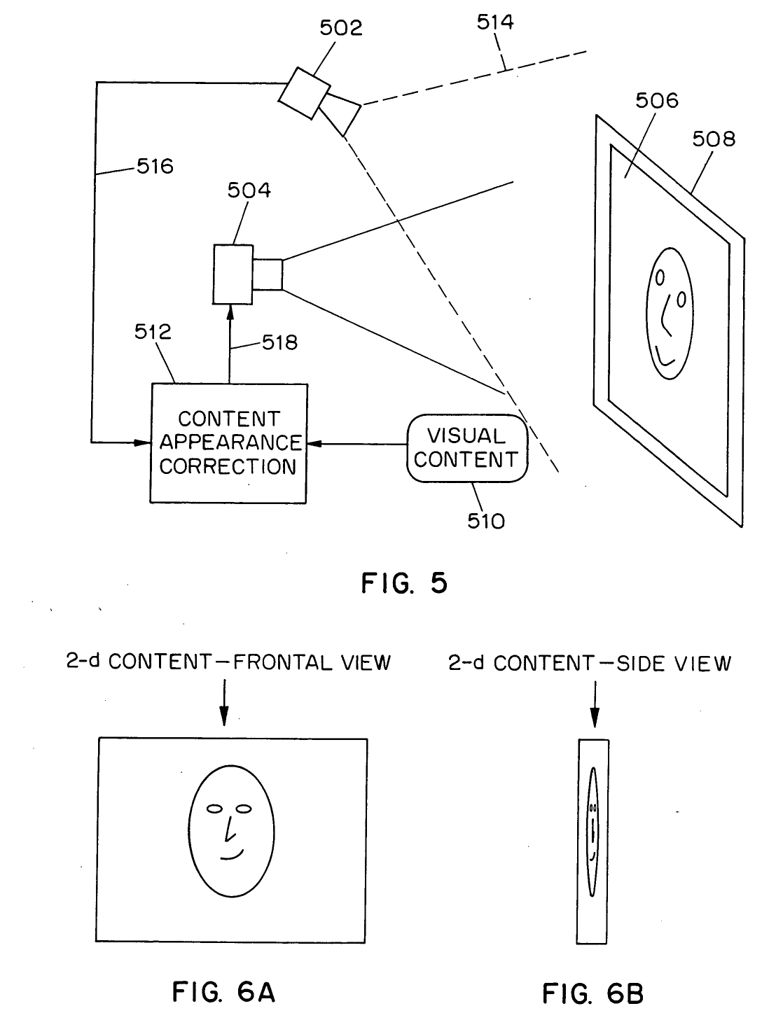

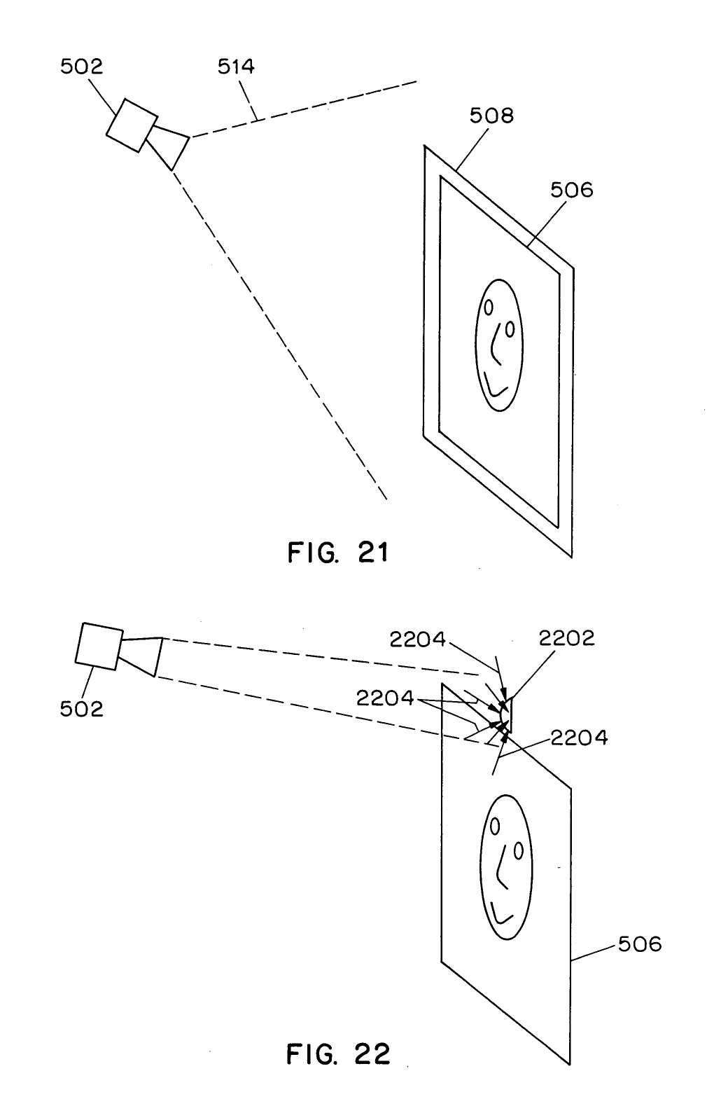

An additional approach to measuring the illumination energy field is to use diffusely reflecting markers on the physical device and observe/measure the brightnesses of the markers using a sensor such as a video camera. If the reflector is Lambertian (i.e., reflects equally in all directions), the brightness at each point on the marker is proportional to the illumination energy incident from the environment at that point. In other words, the radiance at a point (s,t) of the diffuse reflector is:

$$L ( s , t ) = \frac{ρ}{π} \hat{E} ( s , t ) \qquad ( 2 )$$

where, ρ is the “albedo” (i.e., reflectively) of the diffuse reflector. In the exemplary imaging systems illustrated in FIGS. 5 and 21, the image brightness measured along the diffuse reflector 508 is directly proportional to the illumination energy field along the reflector.

FIG. 5 illustrates an example of a lighting detection system which utilizes a detector 502—e.g., a still camera or video camera—to detect light signals 514 produced by environmental light reflected from a diffuse (e.g., Lambertian) reflector 508 which is placed adjacent to the display region 506. The brightness at each point on the reflective element 508 is proportional to the incident illumination energy at that point, and because the reflective element 508 has Lambertian reflection characteristics, the direction from which the environmental light is received generally has little or no effect on the brightness at each point on the reflector 508. The illustrated Lambertian reflector arrangement is used to measure the illumination energy field along the periphery of the display region 506. In many cases, it is not necessary to position any reflectors within the display region 506, because the information regarding the brightness along the periphery of the display region 506 is sufficient to perform a simple interpolation operation in order to estimate the illumination energy field at any point within the display region 506.

The environmental lighting information 516 is received by a processor 512 which uses the information 516 to process input information 510 regarding the object to be displayed. The resulting image 518 is a simulation of the object as if illuminated according to the environmental lighting. The image 518 is sent to a projector 504 and displayed in the display region 506.

A diffuse, reflective marker used to detect environmental lighting need not be a linear strip such as the strip 508 illustrated in FIG. 5. For example, a small number of diffuse patches can be attached to the display device at convenient locations.

In addition, reflective markers in accordance with the present invention need not be Lambertian, or even diffusely reflecting. The markers can, in fact, have any known reflectance property suitable for the measurement of the illumination field. For example, the system can use a specular (i.e., mirror-like) reflector to obtain directional information regarding the light rays striking the display region. FIG. 22 illustrates the use of a curved mirror 2202 for reflecting the environmental illumination. The illustrated system performs a direct measurement of illumination signals 2204 from the environment, as seen from close to the display region 506. The curvature of the mirror 2202 enables the measurement system to have a wide field of view.

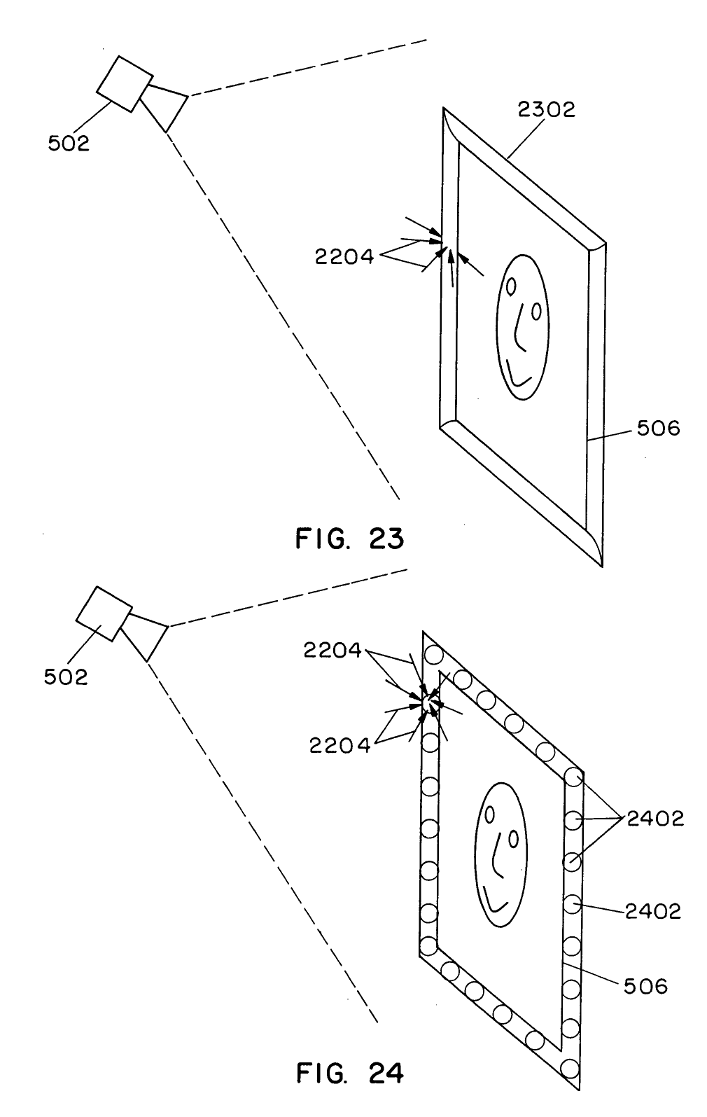

The detector 502 need not be located at a great distance from the display, or in fact, at any distance. It can even be attached to the display device at any desired location, provided that it is oriented so that it can view the marker(s) 508 and/or 2202. In addition, as illustrated in FIGS. 23 and 24, respectively, the system can use more complex marker shapes such as mirrored tubes 2302 and/or mirrored beads 2402. In general, the shapes of the reflective markers are chosen so as to enable dense sampling of the illumination field. The system calculates a mapping between the measurements and the illumination field, in which each measurement (i.e., each pixel) in the image is mapped to a unique location on the marker. In other words, each pixel corresponds to a particular line of sight from the camera, and this line of sight intersects the surface of the marker at an intersection point. The pixel is mapped to this intersection point. Let v denote the unit vector along the line of sight between a camera pixel and the observed marker point corresponding to the pixel. Let the surface normal vector of the marker at that point be denoted as n. At each observed marker point, the surface normal n, the shape of the marker, and the position and orientation of the marker relative to the camera are all known, because these quantities are easily predetermined when the hardware is designed and built. Since v and n are known quantities and the surface of the marker is a reflector, the direction vector s of the illumination field ray 2204 can be determined as follows:

$$s = \frac{v + n}{‖ v + n ‖} \qquad ( 3 )$$

Thus, the location on the marker and the direction vector s uniquely determine the ray (s, t, u, v,) in the illumination field. The brightness and color of the image measurement (i.e., the image pixel) represent the environmental illumination properties associated with this particular ray direction. Enhanced real-time computational speed can be achieved by pre-computing s for many values of v and n in advance, and storing the results in a lookup table for later use.

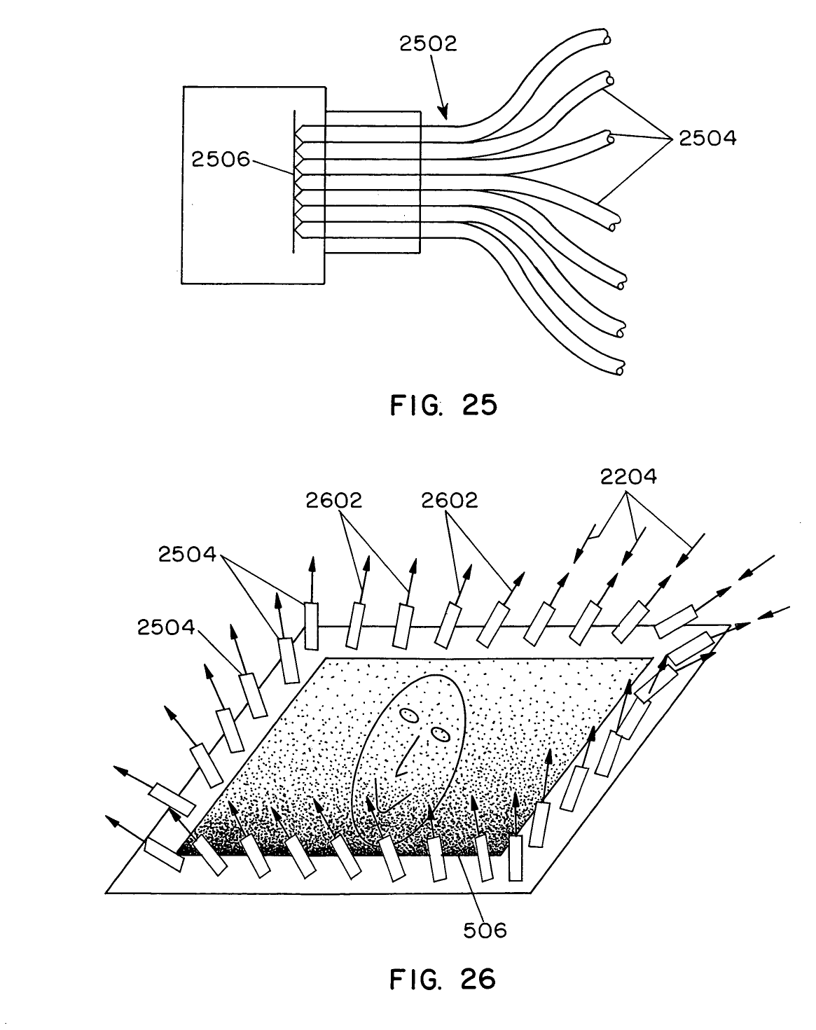

An additional method for capturing multiple measurements of an illumination field illustrated in FIG. 25, uses at least one fiber optic bundle 2502. In the illustrated example, a dense bundle 2502 of fibers 2504 is used to carry optical signals to an image detector 2506 such as, for example, a CMOS or CCD detector. The input end of each fiber 2504 in the bundle 2502 can be placed in any location to obtain a measurement of the local illumination field. A very large number of fibers 2504 can be packed into a single bundle 2502, thereby enabling the system to simultaneously obtain samples of the directional illumination field in many directions. Furthermore, the sampling can be repeated at a high repetition rate. A fiber 2504 can be considered to be a local illumination energy detector. However, in contrast to the essentially non-directional photo-detectors discussed above, a typical fiber 2504 tends to have a narrower cone of sensitivity and can therefore be used to capture directional attributes of an illumination field.

An exemplary arrangement of fibers 2504, illustrated in FIG. 26, includes a set of fibers 2504 distributed around the display region 506, each fiber 2504 pointing in a unique direction 2602 and receiving an illumination light signal (i.e., an incident light ray) 2204 from approximately that direction 2602. Such an arrangement provides a coarse, but useful, sampling of the illumination field. The measured irradiance values can be denoted as E(sᵢ,tᵢ,uᵢ,vᵢ). Similarly to the procedures discussed above with respect to non-directional photodetectors, a variety of interpolation techniques can be used to estimate an irradiance value at any location within the display region, using the finite set of fiber optic measurements. In fact, if fibers or other directional sensors are used, interpolation can readily be performed not only with respect to location within the display region, but also with respect to the direction of the light source.

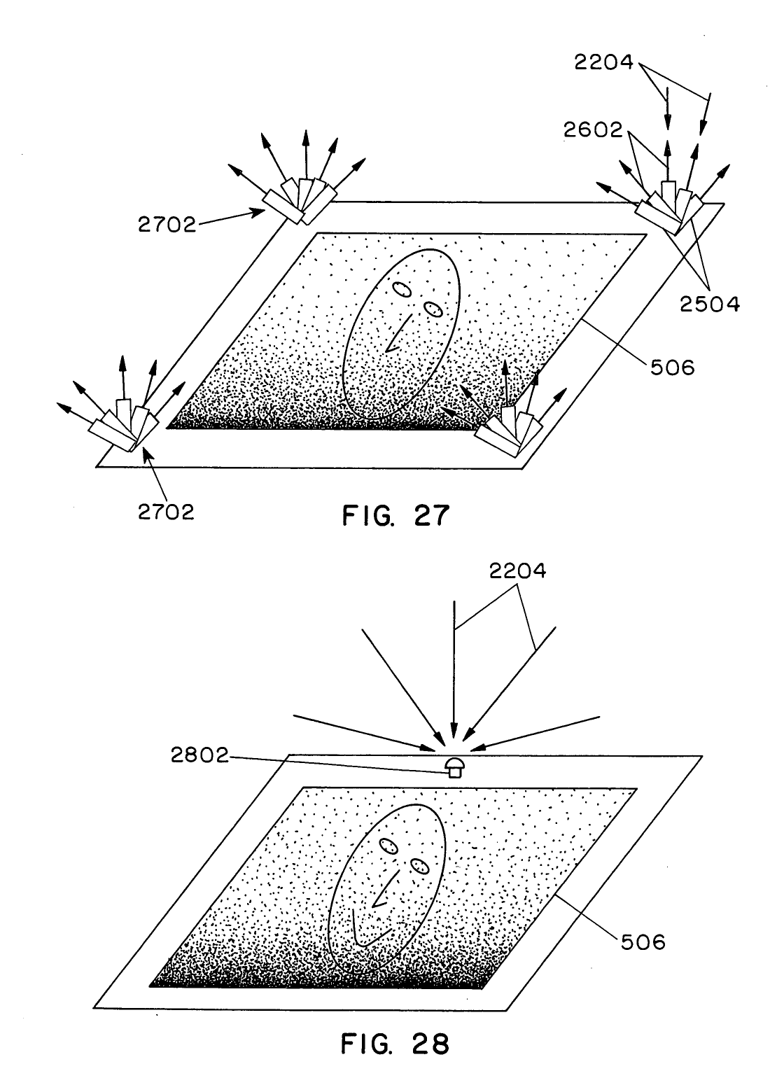

As illustrated in FIG. 27, optical fibers 2504 can also be arranged in local clusters 2702 in which each fiber 2504 of a particular cluster 2702 points in a different direction 2602. Each cluster 2702 measures the angular (i.e., directional) dependence of incident energy at the location of that cluster 2702. In other words, each cluster 2702 measures the local illumination field E(sᵢ,tᵢ,uⱼ,vⱼ)—i.e., the irradiance coming from each of a plurality of directions (uⱼ,vⱼ)—at a given location (sᵢ,tᵢ) The local illumination fields provided by the fiber clusters 2702 can in turn be used to estimate (by interpolation) the local illumination field at any point of interest in the display region 506.

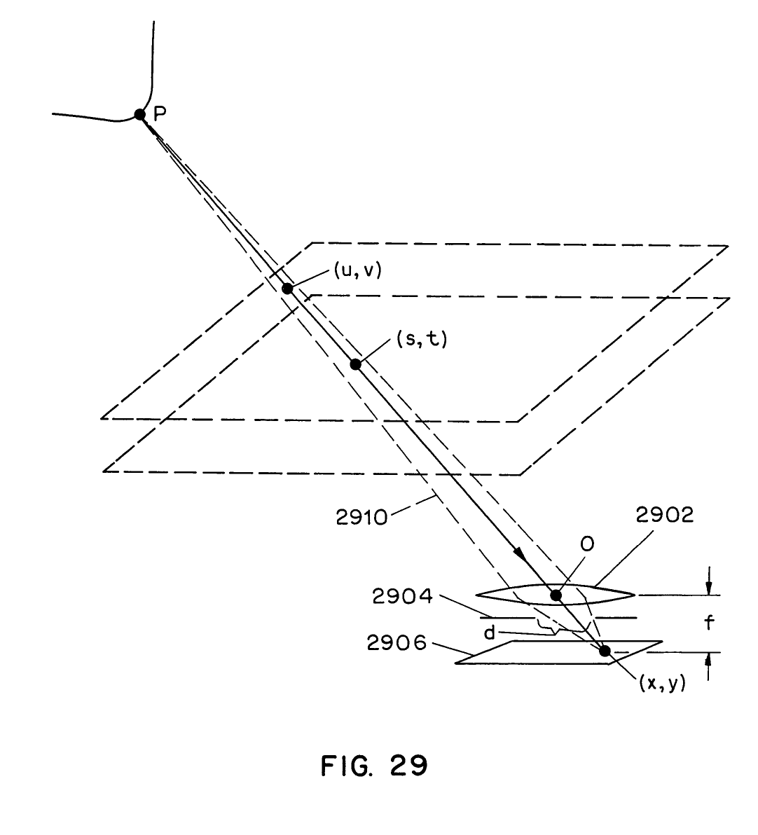

FIG. 28 illustrates an exemplary technique for using a video camera 2802 for capturing a dense sampling of a local illumination field. In the illustrated example, the video camera is used to generate an image of the environmental light sources by detecting incoming illumination signals (i.e., incident light rays) 2204 from a fixed location on or near the display region 506. Preferably, the imaging of the environmental lighting is performed using a wide angle imaging system having a hemispherical field of view. The relationship between the resulting lighting image brightness values and the received illumination field is illustrated in FIG. 29. For simplicity, the system is illustrated as having a perspective imaging lens 2902 rather than a wide angle imaging lens. However, the analysis also applies to wide angle imaging systems. As illustrated in FIG. 29, there is a unique mapping between the image coordinates (x, y) and the incoming ray (s, t, u v), because each image point (x, y) corresponds to a unique ray (s, t, u v) that passes through both the image point (x, y) and the entrance pupil 0 of the imaging lens 2902. Each such ray (s, t, u v) can be referred to as a “chief ray.” Each chief ray (s, t, u v) is accompanied by a bundle 2910 of rays around the chief ray (s, t, u v); this is generally the case in any imaging system with a non-zero aperture 2904. If the distance between the image plane 2906 and the lens center 0 is denoted as f (a/k/a the “effective focal length”), the diameter of the aperture is denoted as d, and the chief ray (s, t, u v) has an angle a with respect to the optical axis, it is a well known principle that the image irradiance E(x, y) is related to the radiance L(s, t, u v) of the corresponding scene point P as follows:

$$E ( x , y ) = L ( s , t , u , v ) g ( α , d ) \frac{π}{4} {( \frac{d}{f} )}^{2} {cos}^{4} α \qquad ( 4 )$$

In other words, image irradiance is proportional to scene radiance, and therefore, the captured image can be used to compute the local illumination field. The measurement is also very dense with respect to directional sampling, because video sensors typically have a million or more individual sensing elements (i.e., pixels). The factor g(α, d)—which is equal to unity in the case of a simple lens system such as the one illustrated in FIG. 29—is preferably used to account for any brightness variations across the field of view, which can be caused by vignetting or other effects which are common in compound and wide angle lenses.

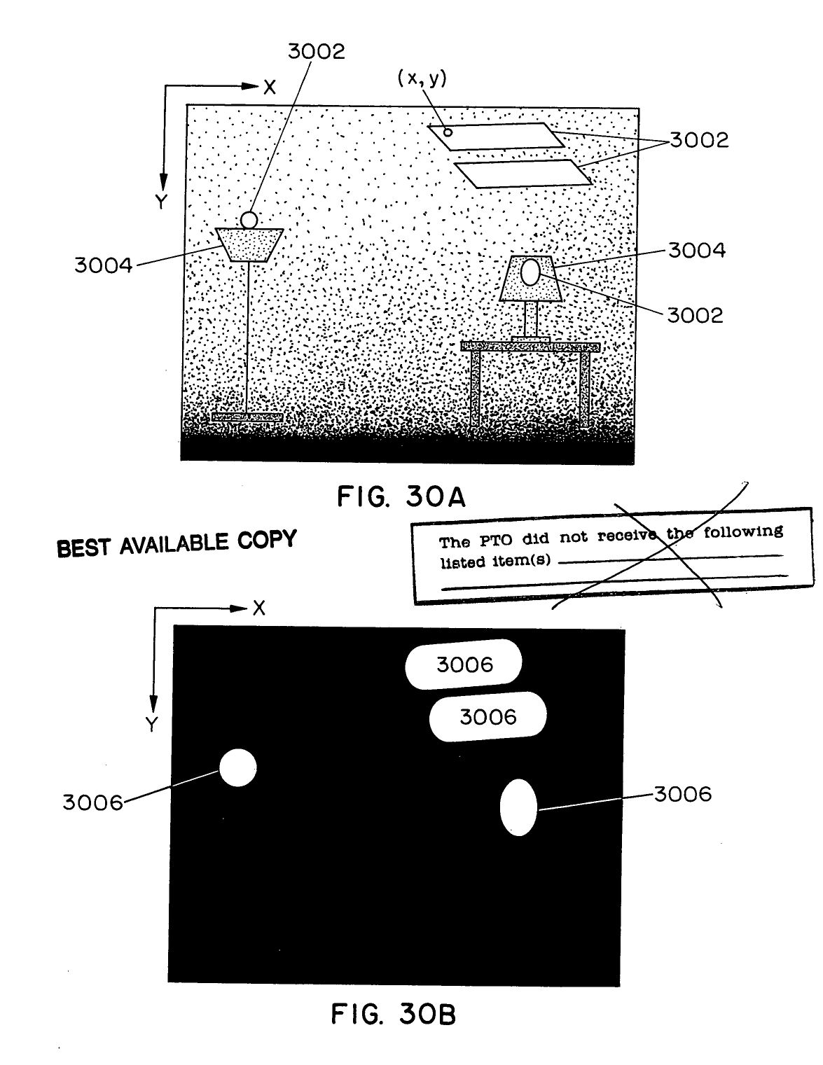

An example of an environmental lighting image captured by a video camera is illustrated in FIG. 30A. As illustrated in the drawing, direct light sources 3002 tend to be bright compared to the other features 3004 in the scene. As a result, in some cases, because of the camera's limited dynamic range, the camera may not be able to accurately capture all of the details of the environmental illumination. For relatively cost-insensitive applications, a high-dynamic-range camera (e.g., a camera providing 12 bits of brightness resolution per pixel) can be used to overcome the resolution limitation. For more cost-sensitive applications, other methods are preferable. For example, one relatively inexpensive technique is to capture multiple images of the scene, each image being captured under a different exposure setting. High-exposure images tend to accurately reveal illumination field components caused by diffuse reflecting surfaces in the scene. Low-exposure images tend to accurately capture, without saturation, bright sources and specular reflections from smooth surfaces. By combining information from the multiple images, a dense and accurate measurement of the local illumination field is obtained.

The exposure setting of the imaging system can be varied in many ways. For example, in a detector with an electronic shutter, the integration time while the shutter is open can be varied. Alternatively, or in addition, the aperture of the imaging lens can be adjusted. An additional method comprises slightly defocusing the imaging system. Defocusing tends to blur the illumination field image, but brings bright sources within the measurable range of the image sensor. Once the image has been captured, it can be spatially high-pass filtered to generate an approximate reconstruction of the illumination field. The computed brightness values in the resulting high-pass filtered image can exceed the maximum brightness value otherwise detectable by the sensor.

In determining the illumination field, a variety of approximations can be made in order to enhance computational efficiency. For example, if a three-dimensional object is to be rendered in real-time using the computed illumination field, and computational speed and efficiency are important, it is preferable to avoid using a fine sampling of the field. In such cases, a coarser description of the field can be obtained by extracting the “dominant” sources in the environment—i.e., sources having brightness and/or intensity values well above those of the other portions of the environment. As illustrated in FIG. 30B, the extraction procedure results in a small number of source regions 3006. Each source region 3006 can be compactly and efficiently described according to its area, second moment, and brightness. These simple attributes can be used to reduce the complexity of the rendering computation, although some precision is sacrificed in order to achieve the reduced complexity. A light source can be modeled as a point source—i.e., as a point intensity pattern—or as a geometrical region having uniform intensity inside and zero intensity outside—i.e., as a uniformly bright shape surrounded by a dark region.

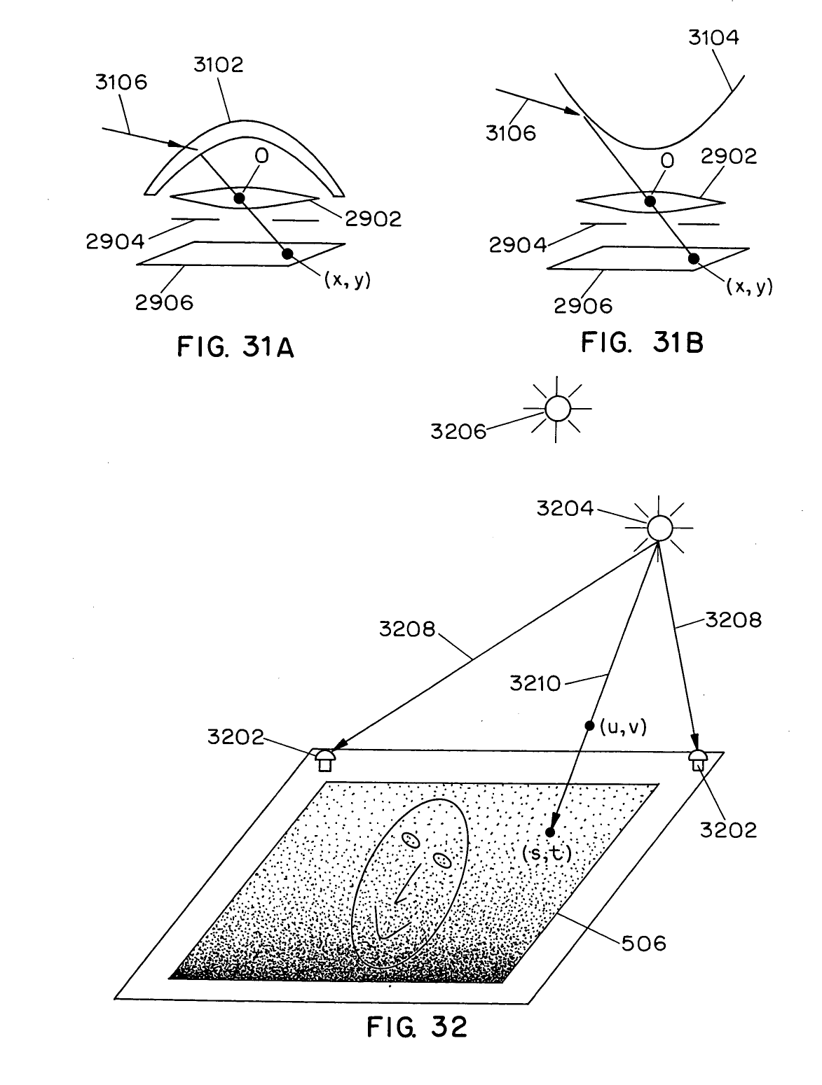

In the case of a wall-hanging display, all of the sources of illumination are typically located in front of the display. It would be ideal to have a wide-angle imaging system that can simultaneously capture information regarding all relevant light sources. A fish-eye lens attached to a video sensor would be suitable in such cases. Yet, in most cases, a highly detailed image of the environment is unnecessary. Rather, it is usually sufficient to characterize only the dominant sources of illumination. In fact, the exact shapes and locations of these sources are not required for achieving a high degree of realism with respect to most types of rendered content. Therefore, the captured images of the environmental light sources need not have high quality over the entire field of view. Accordingly, existing imaging systems—such as, for example, the compact cameras often included in conventional laptop and desktop computer systems—are typically capable of achieving the desired resolution, although for some imagers, simple modifications are preferably made. FIGS. 31A and 31B illustrate two such modifications. In the arrangement illustrated in FIG. 31A, a meniscus lens 3102 is positioned in front of a conventional, imaging lens 2902 having a narrow field of view. The meniscus lens 3102 causes increased bending of light rays 3106 which have a relatively large angle with respect to the optical axis of the imager. As a result, such a lens 3102 widens the field of view of the imaging system. Another approach, illustrated in FIG. 31B, is to use a curved mirror 3104 to image the environment. It is well known that the field of view of an imaging system can be significantly enhanced by using such a curved mirror 3104.

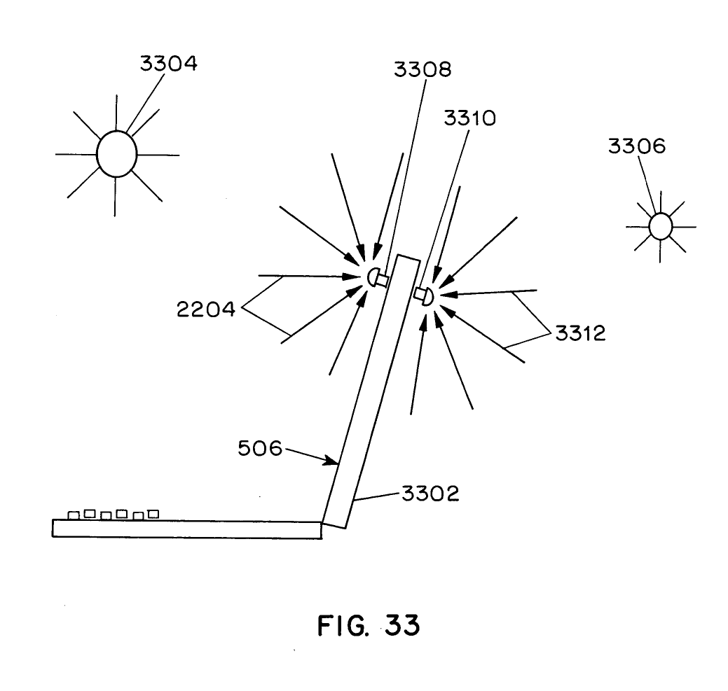

The illumination field measurement can also be performed stereoscopically, as is illustrated in FIG. 32. In the illustrated example, two wide-angle imaging systems 3202 are located at detection points adjacent to the display region 506, but at a distance from each other. The detection points can also be within the display region 506. Each of the two imaging systems 3202 measures a local illumination field resulting from one or more environmental sources 3204 and 3206. The two resulting images are compared in order to find matching features. In particular, the system determines where a scene feature 3204 appears in the first image, and also determines where the same scene feature 3204 appears in the second image. Scene features of interest can include either direct illumination sources or surfaces or which reflect light from illumination sources. In either case, an illumination source 3204 produces light signals 3208 which are received by the imagers 3202. The imagers 3202 detect the brightness and/or color of each of the light signals 3208. The source also produces light signals (e.g., signal 3210) which are received in the display region 506. Typically, each light signal is a light ray bundle having a particular chief ray, and each bundle is focused and detected by the imager 3202 receiving it. In accordance with well-known optics techniques, the location at which a scene point 3204 appears in an image is used to determine a corresponding ray extending from the imager to the scene point 3204. Furthermore, the scene point 3204 is known to be located at the intersection of the corresponding ray in the first image and the corresponding ray in the second image. Therefore, the three-dimensional coordinates—including angular position and depth position—of the scene point 3204 can be computed by triangulation. The triangulation procedure is repeated for each of pair of rays corresponding to each scene point having sufficient brightness to be relevant. The result is a dense description of the locations of illumination radiators in three-dimensional space. The radiance of each radiator is L(xᵢ,yᵢ,zᵢ). These discrete measurements are preferably interpolated to obtain a continuous representation L(x, y, z)—or at least a denser discrete representation—of the environment illumination. The resulting three-dimensional description of the environmental illumination is used to estimate the local illumination field at any point in the display region. Consider, for example, the point (s, t) illustrated in FIG. 32. The irradiance received by the point (s, t) from a particular direction (u, v) is easily calculated by determining the value of the measured illumination L(x, y, z) at the point of intersection of the ray (s, t, u, v) and the plane of the display region 506. The above stereoscopic approach for computing the environmental illumination provides good approximation of the complete illumination field within the display region 506.

As discussed above, in cases in which the illumination behind a display is sufficiently bright to have a strong effect on the viewer's visual perception of the displayed image, it is advantageous to measure the illumination field not only in front of the display region 506, but also behind the display region 506. The additional measurement enables the system to adjust the displayed content based on the background illumination, as well as the foreground illumination. In the arrangement illustrated in FIG. 33, a wide angle imaging system 3308 is used to measure the illumination field in front of the display region 506 of a laptop computer 3302. An additional wide angle imaging system 3310 is used to measure the illumination field behind the display region 506. The first imager 3308 detects signals 2204 received from sources (e.g., sources 3304) in front of the display region 506, and the second imager 3310 detects signals 3312 received from sources (e.g., source 3306) behind the display region 506.

In addition to environmental lighting effects, there are other possible causes of imperfections in a displayed image. Such causes can include, for example, imperfections in a screen or wall on which an image is projected, imperfections in the radiometric and spectral response of the display device, and/or imperfections in the surface of the display device—such as, for example, dust particles, scratches, and/or other blemishes on the display surface. In the case of “passive” viewing screens such as those used for rear projection televisions, film projectors, LCD projectors, and DLP projectors, the screens can become marked or stained over time. Furthermore, film projectors, LCD projectors, and DLP projectors are often used to project images onto viewing screens such as walls or other large surfaces which are even more likely to have surface markings, and furthermore, are often painted/finished with non-neutral colors. Consider, for example, projecting an image or movie on a mahogany door. Not only is the door likely to have a reddish tint, but it is also likely to have elongated markings caused by the wood grain. Both the overall color of the door and its markings will tend to cause the projected image to be displayed incorrectly. It is highly desirable to have a method that can enable a projection system or other display system to correct for the above-mentioned effects, in addition to environmental lighting effects. In the case of projection systems, such a method is particularly desirable for enabling projection of visual content on surfaces—e.g., the wall of a room—that are not designed to serve as projection screens. Therefore, in accordance with an additional aspect of the present invention, a displayed image can be adjusted and/or corrected using an adjustment procedure which monitors the appearance of the displayed image and adjusts the input signals received by the display device in order to correct errors and/or imperfections in the appearance of the image. The displayed image can be monitored using any conventional camera or imager, as is discussed in further detail below. In addition, a calibration procedure can be performed using a test image. The test image is displayed and its appearance is monitored in order to generate adjustment information which is used to adjust subsequent images.

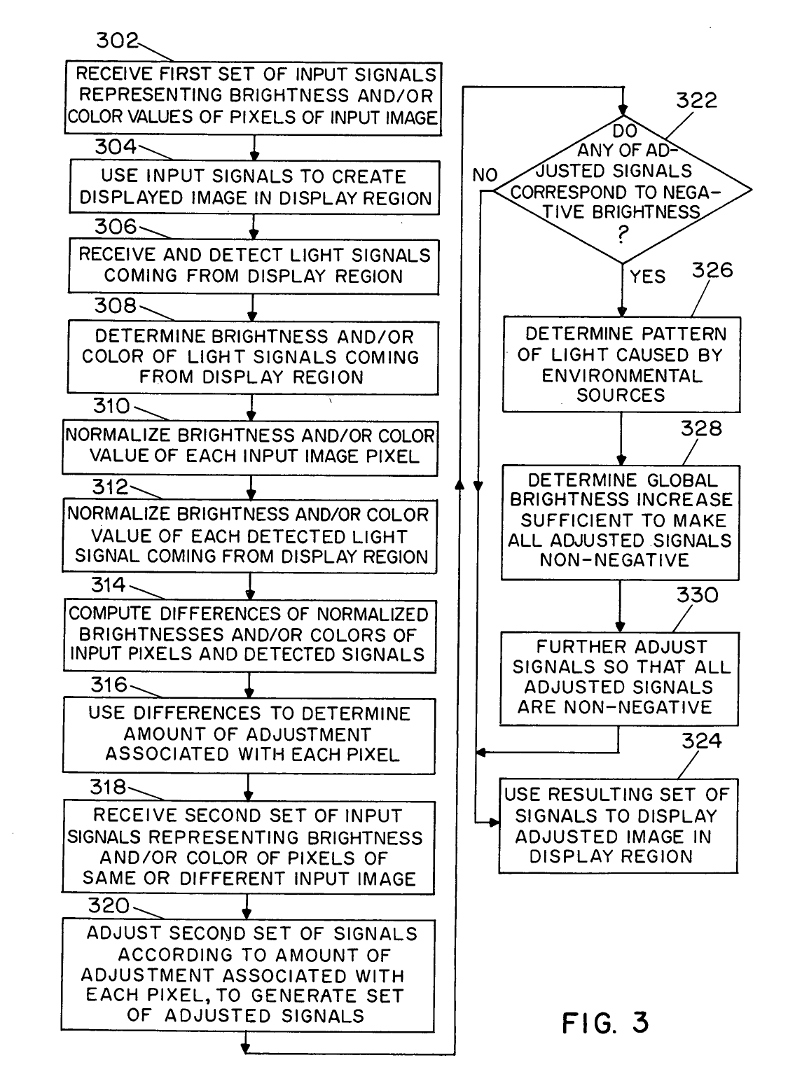

An exemplary procedure for adjusting a displayed image in accordance with the present invention is illustrated in FIG. 3. A display device or a processor receives a first set of input signals representing the brightness values and/or color values of a set of pixels representing an input image (step 302). The display device uses the input signals to create a displayed image in a display region 506 which can be, for example, a computer screen or a surface on which an image is projected (step 304). A camera or other imager is used to receive and detect light signals coming from the display region (step 306). Each light signal coming from the display region corresponds to a particular portion (e.g., pixel) of the displayed image. The imager determines the brightness and/or color of the light signals coming from the display region (step 308). The detected brightness and/or color of the light signals received by the imager can be affected by factors such as, for example, the distance between the imager and the display region, the sensitivity of the imager, the color-dependence of the sensitivity of the imager, the power of the display device, and the color-dependence of the display characteristics of the display device. Accordingly, it is preferable to normalize the brightness and/or color values of each input image pixel and/or each detected light signal coming from the display region (steps 310 and 312), in order to enable the system to accurately compare the brightnesses and/or colors of the input pixels and the detected light signals. The difference of the (preferably normalized) brightness or color of each input pixel is compared to that of the corresponding detected signal in order to compute the difference of these characteristics (step 314). The computed differences are used to determine an amount of adjustment associated with each pixel of the image being displayed (step 316).

The appropriate amount of adjustment for a particular pixel depends not only upon the computed difference between the input value and the detected value for the pixel, but also on the physical characteristics of the display system. Such characteristics typically include the display gain curve at that pixel, the imager sensitivity at that pixel, the input value, and the characteristics of the optics of the imager. Well-known techniques can readily be used to determine a mathematical relationship between the computed difference value and the amount of adjustment required. Furthermore, enhanced real-time computational speed can be achieved in a particular system by using the system characteristics to pre-compute, in advance, the proper amount of adjustment for many different potential values of input brightness, input color, pixel location, and computed difference between input value and detected value. The pre-computed results and the corresponding input parameters of the computations are stored in one or more lookup tables for later use.

It is to be noted that the portion of the procedure which comprises steps 302, 304, 306, 308, 310, 312, 314, and 316 can be used as a one-time calibration procedure, or optionally can be repeated in real time as the displayed image is updated and/or changed. In any case, a second set of input signals is received (step 318). Each input signal of the second set represents a characteristic such as the brightness and/or color of a pixel of an input image. The input image in step 318 can be the same input image as the one received in step 302, or can be a different input image. Typically, the second image is different from the first image if the system is being used to display a video stream or other sequence of images. The second set of signals is adjusted according to the amount of adjustment associated with each pixel (as computed in step 316), in order to generate a set of adjusted signals (step 320).

In many cases, the system can be effectively used to cancel out spurious light signals caused by directional or non-directional reflections of environmental light. For example, as is quite familiar to many people who have viewed projected slide shows and/or movies in a room with imperfectly-shaded windows, light from outside the room frequently causes undesirable bright spots on the wall and/or projection screen upon which the displayed image is being projected. The bright spots are typically non-specular—i.e., non-directional—reflections of the outside light. The image correction procedure illustrated in FIG. 3 compensates for such spurious reflections by darkening the corresponding regions of the projected image sufficiently to cancel out the undesired reflections. Yet, if a particularly bright, spurious reflection falls upon a portion of the display region in which the projected image is relatively dim, even reducing that portion of the projected image to complete darkness may. not be sufficient to completely cancel the spurious reflection. In other words, the adjusted signal calculated in step 320, above, may, in fact, be negative. Because available systems are incapable of generating negative light, it is difficult to completely correct for such strong, spurious reflections. A solution to this difficulty is to increase the brightness of every portion of the displayed image sufficiently to prevent any of the adjusted signals from corresponding to negative brightness. Such a procedure is illustrated as part of the flow diagram of FIG. 3. If, after step 320, any of the adjusted signals correspond to negative brightness (step 322), the system determines the pattern of light caused by environmental sources (step 326), and determines an amount of global brightness increase sufficient to cause all of the adjusted signals to be non-negative (step 328). The global brightness adjustment is applied to the adjusted signals from step 320, such that all of the adjusted signals are non-negative (step 330). The resulting set of signals is used to display an adjusted image in the display region (step 324). If, on the other hand, after step 320, none of the adjusted signals correspond to negative brightness (step 322), no additional global adjustment is needed, and the system simply uses the adjusted signals from step 320 to display the adjusted image in the display region (step 324). Optionally, the illustrated image-adjustment procedure can be repeated periodically, or can be performed a single time—e.g., when the display system is powered on.

For color images, the procedure illustrated in FIG. 3 can be further understood as follows. Let the desired image be denoted as d(x,y), where x denotes the horizontal coordinate of a pixel in the corrected image; y denotes the vertical coordinate; and d(x,y) is a three vector having the components dᵣ(x,y) representing the brightness of the pixel's red color channel, d_{g}(x,y) representing the brightness of the pixel's green color channel, and d_{b}(x,y) representing the brightness of the pixel's blue color channel. Let the corrected image be denoted by a similar three vector c(x,y). Now consider a pixel (x,y) in the corrected image corresponding to a point p in the display region 506. This pixel (x,y) is represented by a pixel (xᵣ, yᵣ) in the detected image. Let the detected image be denoted as r(xᵣ, yᵣ). Before the adjustment procedure is performed, the images are geometrically calibrated in order to determine a geometric relation which maps the coordinates of the pixels in the detected image to the coordinates of the pixels in the displayed image. This relation can be represented by the functions xᵣ=f(x, y) and yᵣ=g(x, y). Optionally, the geometric calibration can be done once—as part of the display system manufacturing process or as part of an initialization step each time the unit is powered on. Note that because the coordinates of the desired image and the corrected images are the same, the notation (x, y) is used to denote both.

The display system can be used in an open-loop manner as follows. After the display system is powered on, an initial desired image dᵢ(x, y) is fed to the control unit. The initial image can be any one of a number patterns, including a solid white image. The control unit feeds the initial image to the display system. The display system projects/displays the image within the display region, and the camera detects the resulting light signals emanating from the display region, thereby generating a detected image rᵢ(xᵣ, xᵣ). A “correction gain” image g(x, y) is computed as follows:

$$g ( x , y ) = \frac{{d}_{i} ( x , y )}{{r}_{i} ( {x}_{r} = f ( x , y ) , {y}_{r} = h ( x , y ) )} \qquad ( 5 )$$

where the functions xᵣ=f(x, y) and yᵣ=h(x, y) are used as a mapping between the image coordinates of the input image (or the displayed image) and the image coordinates of the detected image. Enhanced computational speed can be achieved by computing many values of xᵣ and yᵣ in advance, and storing the results in a lookup table to allow fast determination of xᵣ and yᵣ given particular values of x and y.

The correction gain image g(x, y) is stored and used by the control unit to modify each subsequent input image d(x, y) to produce a corrected image c(x, y). The corrected image c(x, y) is computed as follows:

c(x, y)=d(x, y)×g(x, y) (6)

where the × symbol denotes pixel-wise multiplication. The above-described correction process is repeated for each desired image that is sent to the display system. The computation of the correction gain image can optionally be performed: (1) once at startup, (2) at user-selected times during the display process, (3) at various predetermined intervals during the display process, and/or (4) repeatedly as each new input image is sent to the display device.

The display system can also be used in a closed-loop manner in which the correction algorithm is iterated as part of a correction feedback loop. Let the correction image at time t be denoted as c(x, y, t); accordingly, let the initial—or first—correction image be denoted as c(x, y,0), and let the correction image one iteration after time t be denoted as d(x, y, t) and r(x,y,t), respectively. The first time through the iterative loop, the correction image is set equal to the desired image, i.e., c(x, y, 0)=d(x, y, 0). The feedback loop can then be described by the following recursion equation:

c(x, y, t+1)=c(x, y, t)+g×(d(x, y, t)−r(xᵣ, yᵣ, t)) (7)

where g is a gain constant satisfying the inequality ∥1−g∥<1.

Preferably, the correction iterations are performed at the refresh rate of the display device.

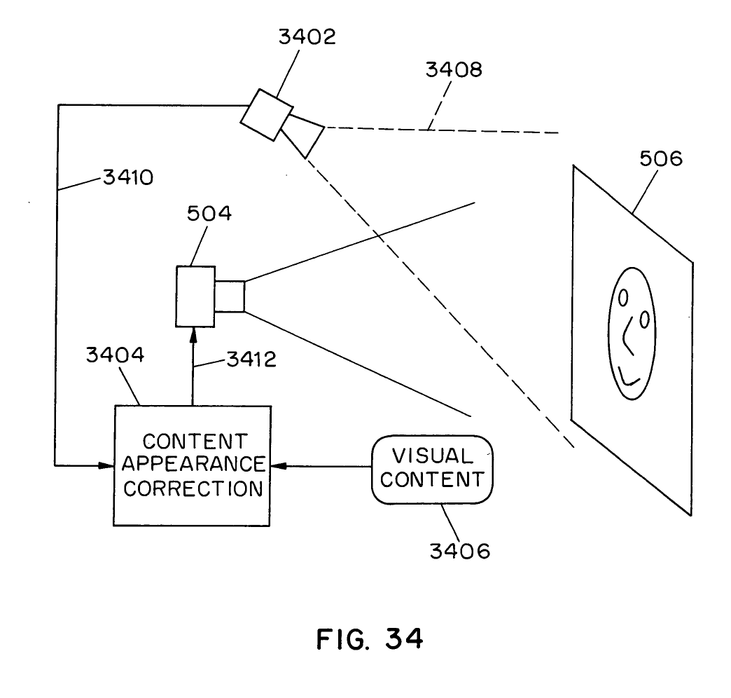

FIG. 34 illustrates an example of a projection-based system that can be used to perform the procedure illustrated in FIG. 3. The system includes a projector 504 for projecting images onto a display region 506, and also includes a detector 3402—typically a camera or other imager—for detecting light signals 3408 coming from the display region 506. A processor 3404—which can optionally be incorporated into the projector 504 or the detector 3402—receives input content 3406 and also receives detected image signals 3410 from the detector 3402. The processor 3404 processes the input content 3406 and the detected image signals 3410 in accordance with the procedure illustrated in FIG. 3, in order to generate adjusted images 3412 which are sent to the projector 504 to be displayed.

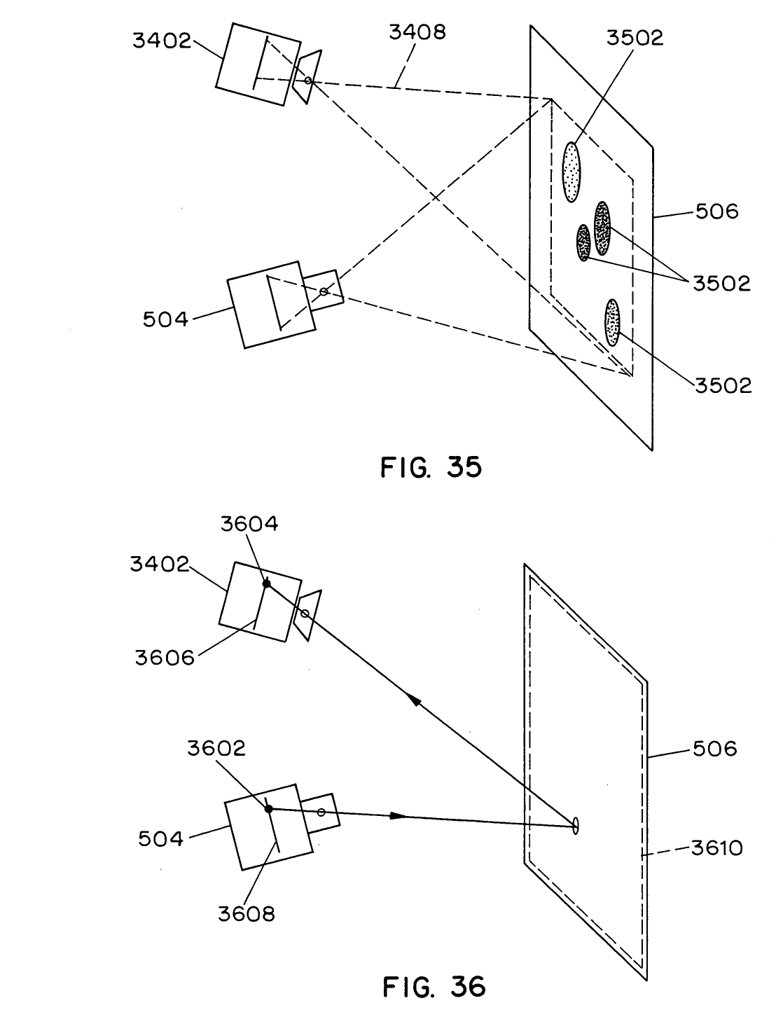

FIG. 35 illustrates the use of the projection system illustrated in FIG. 34 and the procedure illustrated in FIG. 3 for correcting image imperfections caused by surface markings 3502 in the display region 506. The surface markings 3502 introduce errors in brightness and/or color, and these errors are corrected as discussed above, using the procedure illustrated in FIG. 3.

In order to accurately apply the adjustment procedure to a displayed image, the system calculates a geometric “mapping” between each point in the input image and the corresponding point in the displayed image. Such a mapping is straightforward to compute using an off-line calibration procedure. Consider, for example, an input image 3608 which includes a first point 3602, as is illustrated in FIG. 36. The first point 3602 corresponds to a second point 3604 in the detected image 3606. The geometrical coordinates of the second point 3604 in the sensed image map to the geometrical coordinates of the first point 3602 in the displayed image. If the displayed image 3610 is on a flat (planar) surface, a relatively small number of discrete mappings are sufficient to calculate a complete affine mapping between the input image 3608 and the detected image 3606. On the other hand, if the display surface has a more complex (e.g., non-planar) geometry, then the mapping for each display image point is preferably determined independently. Such a process can be made more efficient by using standard structured light projection methods based on binary coding. Such projection methods are commonly used in conventional lights-tripe range scanners. In any case, a dense geometric mapping between the camera and the projector can always be computed off-line.

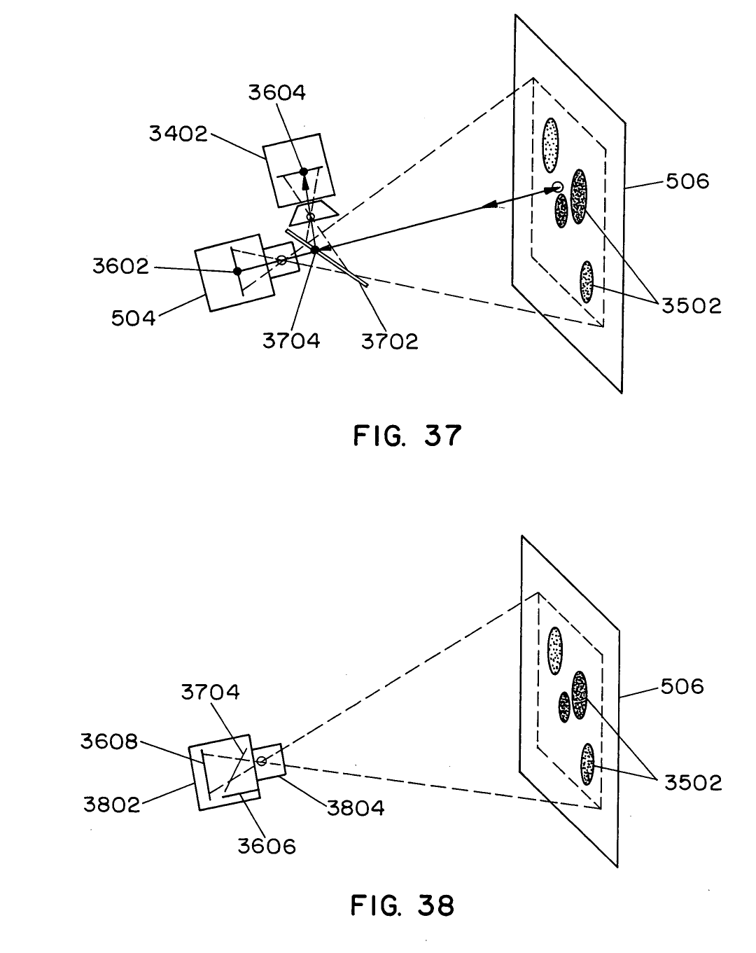

An additional aspect of the present invention enables avoidance of the above calibration procedure by arranging the monitoring detector 3402 such that it is effectively coaxial with the projector optics. An example of such an optically aligned system is illustrated in FIG. 37. In the illustrated system, a beam-splitter 3702 such as half-silvered mirror is used to transmit each pixel of the outgoing image, and reflect the corresponding pixel of the incoming image, from the same point 3704 in space. In the illustrated system, the mapping between the input point 3602 and the detected point 3604 is independent of the shape of the surface onto which the image is being projected. This feature is particularly advantageous if the shape of the display surface changes while an image is being displayed. Such changes in shape commonly occur in screens made of flexible material such as cloth—which can change shape if there is a breeze. Geometric changes can also occur if the projection system moves with respect to the projection screen. In the system illustrated in FIG. 37, a geometric calibration is unnecessary because the mapping is always known, and can be readily used to adjust the brightness and/or color values of displayed pixels in accordance with an adjustment procedure such as the procedure illustrated in FIG. 3.

An additional coaxial arrangement which provides an even more compact system is illustrated in FIG. 38. The illustrated arrangement enables the projector and the monitoring detector to be included in a single, compact unit 3802, by splitting the shared optical path behind a single lens 3804. In other words, the lens 3804 is used for both sensing and projection. The unit projects an image 3608 through a half-silvered mirror 3704 and the lens 3804. Resulting light signals coming from the display region 506 are then received through the same lens 3804 and reflected by the half-silvered mirror 3704 to form a focused image 3606 which is detected by an imaging detector such as, for example, a CCD array.

In some cases, brightness limitations of the display device may prevent the system from providing a perfectly accurate displayed image. Consider, for example, a projection system having a viewing screen with an extremely dark surface marking. In order to compensate for the dark spot in the recorded image, the displayed pixels located within the dark spot are brightened. Yet, because every display system has a finite amount of power, there is a limit to the amount of compensation that can be applied. However, even if the display system has insufficient power to completely compensate for one or more dark regions, the algorithm will still adjust the displayed image to the extent possible, in order to lessen the apparent imperfection(s).

It is to be noted that although the above descriptions have emphasized the application of image correction to projection systems, the procedure illustrated in FIG. 3 can just as easily be used for non-projection systems such as, for example, laptop computers, desktop computers, and conventional televisions.

It will be appreciated by those skilled in the art that the methods of FIGS. 1-4 can be implemented on various standard computer platforms operating under the control of suitable software defined by FIGS. 1-4. The software can be written in a wide variety of programming languages, as will also be appreciated by those skilled in the art. In some cases, dedicated computer hardware, such as a peripheral card in a conventional personal computer, can enhance the operational efficiency of the above methods.

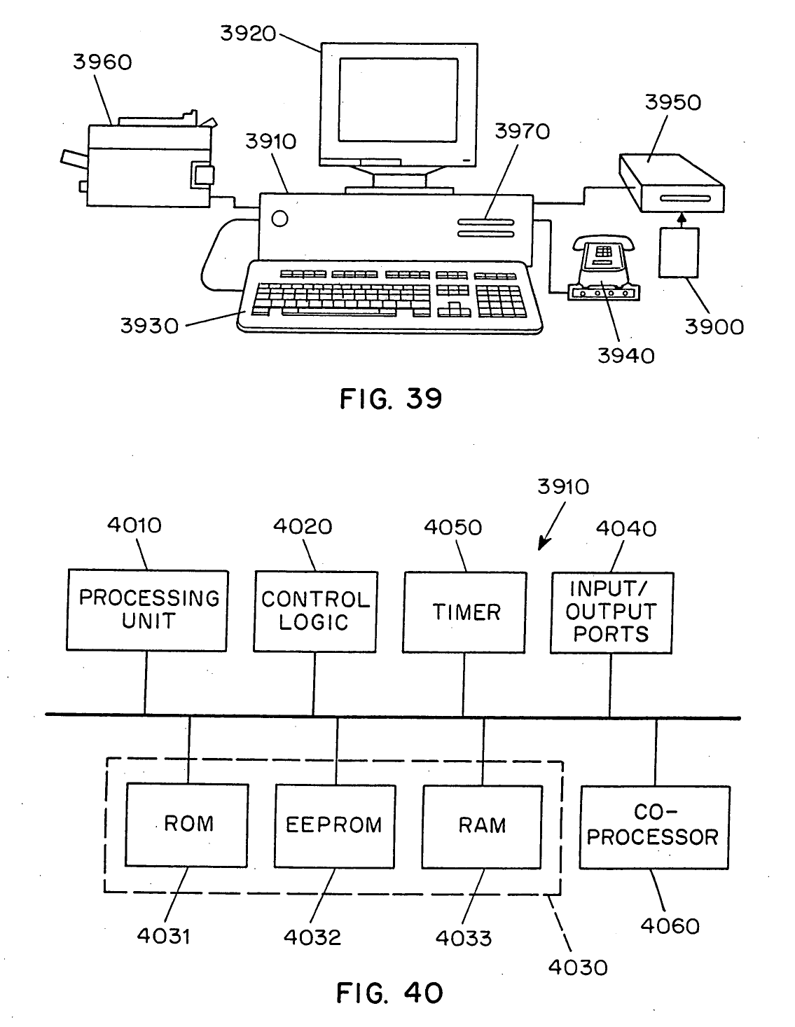

FIGS. 39 and 40 illustrate typical computer hardware suitable for practicing the present invention. Referring to FIG. 39, the computer system includes a processing section 3910, a display device 3920, a keyboard 3930, and a communications peripheral device 3940 such as a modem. The system can also include other input devices such as an optical scanner 3950 for scanning an image medium 3900. In addition, the system can include a printer 3960. The computer system typically includes one or more disk drives 3970 which can read and write to computer readable media such as magnetic media (i.e., diskettes), or optical media (e.g., CD-ROMS or DVDs), for storing data and application software. While not shown, other input devices, such as a digital pointer (e.g., a “mouse”) and the like can also be included.

FIG. 40 is a functional block diagram which further illustrates the processing section 3910. The processing section 3910 generally includes a processing unit 4010, control logic 4020 and a memory unit 4030. Preferably, the processing section 3910 also includes a timer 4050 and input/output ports 4040. The processing section 3910 can also include a co-processor 4060, depending on the microprocessor used in the processing unit. Control logic 4020 provides, in conjunction with processing unit 4010, the control necessary to handle communications between memory unit 4030 and input/output ports 4040. Timer 4050 provides a timing reference signal for processing unit 4010 and control logic 4020. Co-processor 4060 provides an enhanced ability to perform complex computations in real time, such as those required by cryptographic algorithms.

Memory unit 4030 can include different types of memory, such as volatile and non-volatile memory and read-only and programmable memory. For example, as illustrated in FIG. 40, memory unit 4030 can include read-only memory (ROM) 4031, electrically erasable programmable read-only memory (EEPROM) 4032, and random-access memory (RAM) 4033. Different computer processors, memory configurations, data structures and the like can be used to practice the present invention, and the invention is not limited to a specific platform. For example, although the processing section 3910 is illustrated in FIGS. 39 and 40 as part of a computer system, the processing section 3910 and/or its components can be incorporated into either, or both, of a projector and an imager such as a digital video camera or a digital still-image camera.

Although the present invention has been described in connection with specific exemplary embodiments, it should be understood that various changes, substitutions, and alterations to the disclosed embodiments will be apparent to those skilled in the art without departing from the spirit and scope of the invention as set forth in the appended claims.

1. A method for displaying images, comprising:
exposing a display region to first external light comprising a first light ray from a first light source;
receiving first information comprising an approximation of a first characteristic of the first light ray, the first characteristic comprising at least one of a first location of the first light ray, a first direction of the first light ray, a first brightness value of the first light ray, and a first color value of the first light ray;
receiving second information comprising at least one characteristic of an object, the at least one characteristic of the object comprising at least one of a geometrical characteristic and a reflectance characteristic;
using the first and second information to generate a first image of the object, the first image approximating a first view of the object illuminated by the first external light; and
displaying the first image in the display region.

2. A method according to claim 1, further comprising detecting at least one of the first light ray and a second light ray coming from the first external light source for generating the first information.

3. A method according to claim 2, wherein the first characteristic comprises the first direction of the first light ray, and the method further comprises:
generating an image of the first external light; and
using the image of the first external light to generate the first information.

4. A method according to claim 3, wherein the first information further comprises an approximation of a second characteristic comprising at least one of the first brightness value of the first light ray and the first color value of the first light ray, the method further comprising:
receiving third information comprising an approximation of the second characteristic; and
using the third information to generate the first image of the object.

5. A method according to claim 1, further comprising:
detecting a second light ray from the first light source for generating third information comprising an approximation of a second characteristic of the second light ray, the second characteristic comprising at least one of a second brightness value of the second light ray and a second color value of the second light ray;
detecting a third light ray from the first light source for generating fourth information comprising an approximation of a third characteristic of the third light ray, the third characteristic comprising at least one of a third brightness value of the third light ray and a third color value of the third light ray; and
using the third and fourth information to determine the first information.

6. A method according to claim 1, further comprising:
reflecting, by at least one reflective element, at least one of the first light ray and a second light ray from the first external light source, for generating a third light ray; and
detecting the third light ray for generating the first information.

7. A method according to claim 1, further comprising:
detecting a first light ray bundle, including a first chief ray, from the first light source for determining a first direction of the first chief ray;
detecting a second light ray bundle, including a second chief ray, from the first light source for determining a second direction of the second chief ray;
using the first and second directions to determine a three-dimensional location of the first light source; and
using the three-dimensional location to generate the first information.

8. A method according to claim 1, wherein the step of using the first and second information comprises using the first information to generate a model light source pattern for approximating the first external light source, the model light source pattern comprising one of:
a point intensity pattern; and
a distributed intensity pattern having a non-zero, approximately uniform intensity value within a light source region having a selected geometric shape, the distributed intensity pattern having an approximately zero intensity value outside the light source region.

9. A method according to claim 1, wherein the first light ray is incident upon a first portion of the display region at a first time, the method further comprising:
exposing the display region at a second time to second external light comprising a second light ray from one of the first light source and a second light source, the first and the second light rays being incident upon the first portion of the display region;
receiving third information comprising an approximation of a second characteristic of the second light ray, the second characteristic comprising at least one of a second location of the second light ray, a second direction of the second light ray, a second brightness value of the second light ray, and a second color value of the second light ray;
using the second and third information to generate a second image of the object, the second image approximating a second view of the object illuminated by the second light; and
displaying the second image in the display region at approximately the second time.

10. A method according to claim 1, further comprising receiving third information comprising an approximation of a location of a viewer viewing the first image, the at least one characteristic of the object comprising a directional reflectance characteristic of the object, and the step of using the first and second information including using the third information to generate the first image.

11. A method for displaying images, comprising:
providing to a display device, a first signal representing a characteristic of at least a portion of a first image to be displayed, the characteristic of the at least a portion of the first image comprising at least one of a first brightness value and a first color value;
using the first signal to cause the display device to display at least a portion of a second image at a first time and in a first portion of a display region, the at least a portion of the second image comprising an approximation of the at least a portion of the first image;
detecting, at approximately the first time, a first light signal from the first portion of the display region for determining a characteristic of the first light signal, the characteristic of the first light signal comprising at least one of a second brightness value and a second color value;
determining a first difference between the characteristic of at least a portion of the first image and the characteristic of the first light signal; and
using the first difference to determine a first adjustment in the display of a portion of an image in the first portion of the display region of the display device.

12. A method according to claim 11, further comprising:
receiving a second signal representing a third characteristic of at least a portion of a third image, the third characteristic comprising at least one of a third brightness value and a third color value;
adjusting the second signal to obtain the first adjustment in the display of a portion of an image in the first portion of the display region for generating a third signal; and
using the third signal to cause the display device to display at least a portion of a fourth image at a second time and in the first portion of the display region, the second time being after the first time.

13. A method according to claim 12, wherein the at least a portion of the fourth image has a fourth characteristic comprising at least one of a fourth brightness value and a fourth color value, the step of using the first difference comprising using a lookup table to determine an approximate amount of change of the fourth characteristic associated with the step of adjusting the second signal to obtain the first adjustment in the display of a portion of an image in the first portion of the display region.

14. A method according to claim 12, further comprising:
adjusting the second signal to obtain a global adjustment in the display of an image in the display region, for generating the third signal, the global adjustment being sufficiently large to ensure that the third signal represents a non-negative brightness value; and
adjusting a brightness value of at least a portion of a fifth image to obtain the global adjustment in the display of an image in the display region, the at least a portion of the fifth image being displayed at the second time and in a second portion of the display region.

15. A method according to claim 11, wherein the first image portion comprises a first pixel, the second image portion comprising a second pixel, and the method further comprising:
providing to the display device a third signal representing a third characteristic of a third pixel, the third characteristic comprising at least one of a third brightness value and a third color value;
using the third signal to cause the display device to display a fourth pixel in a second portion of the display region, the fourth pixel comprising an approximation of the third pixel;
detecting, during the step of using the third signal to display the fourth pixel, a second light signal from the second portion of the display region for determining a fourth characteristic of the second light signal, the fourth characteristic comprising at least one of a fourth brightness value and a fourth color value;
determining a second difference between the third and fourth characteristics; and
using the second difference to determine a second adjustment in the display of a portion of an image in the second portion of the display region.

16. A method for displaying images, comprising:
receiving a first signal representing a first characteristic of at least a portion of a first image, the first characteristic comprising at least one of a first brightness value and a first color value;
exposing a first portion of a display region to first external light comprising a first light ray from a first light source;
receiving first information comprising an approximation of a second characteristic of the first light ray, the second characteristic comprising at least one of a location of the first light ray, a direction of the first light ray, a second brightness value of the first light ray, and a second color value of the first light ray;
using the first information to determine a third characteristic of a first approximately non-directionally reflected light signal from the first portion of the display region, the third characteristic comprising at least one of a third brightness value and a third color value, and the first approximately non-directionally reflected light signal being caused by the first light ray;
using the third characteristic to determine an adjustment of the first signal;
adjusting the first signal by the adjustment for generating an adjusted signal; and
using the adjusted signal to cause the display of at least a portion of a second image in the first portion of the display region.

17. A method according to claim 16, further comprising detecting at least one of the first light ray and a second light ray from the first light source for generating the first information.

18. A method according to claim 17, wherein the first characteristic comprises the direction of the first light ray, and the method further comprising:
generating a light source image; and
using the light source image to generate the first information.

19. A method according to claim 16, further comprising:
detecting a first incident light signal from the first light source for generating second information comprising at least a fourth characteristic of the first incident light signal, the fourth characteristic comprising at least one of a fourth brightness of the first incident light signal and a fourth color of the first incident light signal;
detecting a second incident light signal from the first light source for generating third information regarding a fifth characteristic of the second incident light signal, the fifth characteristic comprising at least one of a fifth brightness of the second incident light signal and a fifth color of the second incident light signal; and
using the second and third information to determine the first information.

20. A method according to claim 16, further comprising:
reflecting, by at least one reflective element, at least one of the first light and second light from the at least one light source, for generating third light; and
detecting the third light for generating the first information.

21. A method according claim 16, further comprising:
detecting a first light ray bundle having a first chief ray from the first light source for determining a first direction of the first chief ray;
detecting a second light ray bundle having a second chief ray from the first light source, for determining a second direction of the second chief ray;
using the first and second directions to determine a three-dimensional location of the first light source; and
using the three-dimensional location to generate the first information.

22. A method according to claim 16, wherein the step of using the first information comprises using the first information to generate a model light source pattern for approximating the at least one light source, the model light source pattern comprising one of:
a point intensity pattern; and
a distributed intensity pattern having a non-zero, approximately uniform intensity value within a light source region having a selected geometric shape, the distributed intensity pattern having an approximately zero intensity value outside the light source region.

23. An apparatus for displaying images, comprising:
a display region exposed to first external light comprising a first light ray from a first light source;
a first processor for receiving first information comprising an approximation of a first characteristic of the first light ray, the first characteristic comprising at least one of a first location of the first light ray, a first direction of the first light ray, a first brightness value of the first light ray, and a first color value of the first light ray;
a second processor for receiving second information comprising at least one characteristic of an object, the at least one characteristic of the object comprising at least one of a geometrical characteristic and a reflectance characteristic;
a third processor for using the first and second information to generate a first image of the object, the first image approximating a first view of the object illuminated by the first external light; and
a display device for displaying the first image in the display region.

24. An apparatus according to claim 23, further comprising at least one detector for detecting at least one of the first light ray and a second light ray coming from the first external light source for generating the first information.

25. An apparatus according to claim 24, wherein the first characteristic comprises the first direction of the first light ray, the at least one detector comprising an imager for generating an image of the first external light, and the apparatus further comprising a fourth processor for using the image of the first external light to generate the first information.

26. An apparatus according to claim 25, wherein the first information further comprises an approximation of a second characteristic comprising at least one of the first brightness value of the first light ray and the first color value of the first light ray, the apparatus further comprising:
a fourth processor for receiving third information comprising an approximation of the second characteristic; and
a fifth processor for using the third information to generate the first image of the object.

27. An apparatus according to claim 23, further comprising:
a first detector for detecting a second light ray from the first light source for generating third information comprising an approximation of a second characteristic of the second light signal, the second characteristic comprising at least one of a second brightness value of the second light ray and a second color value of the second light ray;
a second detector for detecting a third light ray from the first light source for generating fourth information comprising an approximation of a third characteristic of the third light ray, the third characteristic comprising at least one of a third brightness value of the third light ray and a third color value of the third light ray; and
a fourth processor for using the third and fourth information to determine the first information.

28. An apparatus according to claim 23, further comprising:
at least one reflective element for reflecting at least one of the first light ray and a second light ray from the first external light source for generating a third light ray; and
an imager for detecting the third light ray for generating the first information.

29. An apparatus according to claim 23, further comprising:
a first detector for detecting a first light ray bundle, including a first chief ray, from the first light source for determining a first direction of the first chief ray;
a second detector for detecting a second light ray bundle, including a second chief ray, from the first light source for determining a second direction of the second chief ray;
a fourth processor for using the first and second directions to determine a three-dimensional location of the first light source; and
a fifth processor for using the three-dimensional location to generate the first information.

30. An apparatus according to claim 23, wherein the third processor comprises a fourth processor for using the first information to generate a model light source pattern for approximating the first external light source, the model light source pattern comprising one of:
a point intensity pattern; and
a distributed intensity pattern having a non-zero, approximately uniform intensity value within a light source region having a selected geometric shape, the distributed intensity pattern having an approximately zero intensity value outside the light source region.

31. An apparatus according to claim 23, wherein the display region comprises a first display region portion, the first light ray being incident upon the first display region portion at a first time, the display region being further exposed, at a second time, to second external light comprising a second light ray from one of the first light source and a second light source, the second light ray being incident upon the first portion of the display region, and the apparatus further comprising:
a fourth processor for receiving third information comprising an approximation of a second characteristic of the second light ray, the second characteristic comprising at least one of a second location of the second light ray, a second direction of the second light ray, a second brightness value of the second light ray, and a second color value of the second light ray;
a fifth processor for using the second and third information to generate a second image of the object, the second image approximating a second view of the object illuminated by second light comprising the second light ray; and
a sixth processor for controlling the display device to display the second image in the display region at approximately the second time.

32. An apparatus according to claim 23, further comprising a fourth processor for receiving third information comprising an approximation of a location of a viewer viewing the first image, the at least one characteristic of the object comprising a directional reflectance characteristic of the object, and the third processor comprising a sixth processor for using the third information to generate the first image.

33. An apparatus for displaying images, comprising:
a display device for using a first signal to display at least a portion of a second image at a first time and in a first portion of a display region, the first signal representing a characteristic of at least a portion of a first image to be displayed, the characteristic of the at least a portion of the first image comprising at least one of a first brightness value and a first color value, and the at least a portion of the second image comprising an approximation of the at least a portion of the first image;
a detector for detecting, at approximately the first time, a first light signal from the first portion of the display region for determining a characteristic of the first light signal, the characteristic of the first light signal comprising at least one of a second brightness value and a second color value;
a first processor for determining a first difference between the characteristic of at least a portion of the first image and the characteristic of the first light signal; and
a second processor for using the first difference to determine a first in the display of a portion of an image in the first portion of the display region of the display device.

34. An apparatus according to claim 33, further comprising:
a third processor for receiving a second signal representing a third characteristic of at least a portion of a third image, the third characteristic comprising at least one of a third brightness value and a third color value;
a fourth processor for adjusting the second signal to obtain the first adjustment in the display of a portion of an image in the first portion of the display region, for generating a third signal; and
a fifth processor for controlling the display device to use the third signal to display at least a portion of a fourth image at a second time and in the first portion of the display region, the second time being after the first time.

35. An apparatus according to claim 34, wherein the at least a portion of the fourth image has a fourth characteristic comprising at least one of a fourth brightness value and a fourth color value, the second processor comprising a sixth processor for using a lookup table to determine an approximate amount of change of the fourth characteristic associated with adjusting the second signal to obtain the first amount of adjustment in the display of a portion of an image in the first portion of the display region.

36. An apparatus according to claim 34, further comprising:
a sixth processor for adjusting the second signal to obtain a global adjustment in the display of an image in the display region, for generating the third signal, the global adjustment being sufficiently large to ensure that the third signal represents a non-negative brightness value;
a seventh processor for adjusting a brightness value of at least a portion of a fifth image to obtain the global adjustment in the display of an image in the display region; and
an eighth processor for controlling the display device to display the at least a portion of the fifth image at the second time and in a second portion of the display region.

37. An apparatus according to claim 33, wherein the first image portion comprises a first pixel, the second image portion comprising a second pixel, the display device receiving a third signal representing a third characteristic of a third pixel, the third characteristic comprising at least one of a third brightness value and a third color value, the apparatus further comprising:
a third processor for using the third signal to control the display device to display a fourth pixel in a second portion of the display region, the fourth pixel comprising an approximation of the third pixel;
a fourth processor for controlling the detector to detect, during the step of using the third signal to display the fourth pixel, a second light signal from the second portion of the display region for determining a fourth characteristic of the second light signal, the fourth characteristic comprising at least one of a fourth brightness value and a fourth color value;
a fifth processor for determining a second difference between the third and fourth characteristics; and
a sixth processor for using the second difference to determine a second adjustment in the display of a portion of an image in the second portion of the display region.

38. An apparatus for displaying images, comprising:
a first processor for receiving a first signal representing a first characteristic of at least a portion of a first image, the first characteristic comprising at least one of a first brightness value and a first color value;
a display region having a first display region portion exposed to first external light comprising a first light ray from a first light source;
a second processor for receiving first information comprising an approximation of a second characteristic of the first light ray, the second characteristic comprising at least one of a location of the first light ray, a direction of the first light ray, a second brightness value of the first light ray, and a second color value of the first light ray;
a third processor for using the first information to determine a third characteristic of a first approximately non-directionally reflected light signal from the first display region portion, the third characteristic comprising at least one of a third brightness value and a third color value, and the first approximately non-directionally reflected light signal being caused by the first light ray;
a fourth processor for using the third characteristic to determine an adjustment of the first signal;
a fifth processor for adjusting the first signal by the adjustment for generating an adjusted signal; and
a display device for using the adjusted signal to display at least a portion of a second image in the first display region portion.

39. An apparatus according to claim 38, further comprising at least one detector for detecting at least one of the first light ray and a second light ray from the first light source for generating the first information.

40. An apparatus according to claim 39, wherein the first characteristic comprises the direction of the first light ray, the at least one detector comprising an imager for generating a light source image, and the apparatus further comprising a sixth processor for using the light source image to generate the first information.

41. An apparatus according to claim 38, further comprising:
a first detector for detecting a first incident light signal from the first light source for generating second information comprising at least a fourth characteristic of the first incident light signal, the fourth characteristic comprising at least one of a fourth brightness of the first incident light signal and a fourth color of the first incident light signal;
a second detector for detecting a second incident light signal from the first light source for generating third information regarding a fifth characteristic of the second incident light signal, the fifth characteristic comprising at least one of a fifth brightness of the second incident light signal and a fifth color of the second incident light signal; and
a sixth processor for using the second and third information to determine the first information.

42. An apparatus according to claim 38, further comprising:
at least one reflective element for reflecting at least one of the first light and second light from the at least one light source, for generating third light; and
an imager for detecting the third light, for generating the first information.

43. An apparatus according to claim 38, further comprising:
a first detector for detecting a first light ray bundle having a first chief ray from the first light source for determining a first direction of the first chief ray;
a second detector for detecting a second light ray bundle having a second chief ray from the first light source, for determining a second direction of the second chief ray;
a sixth processor for using the first and second directions to determine a three-dimensional location of the first light source; and
a seventh processor for using the three-dimensional location to generate the first information.

44. An apparatus according to claim 38, wherein the third processor comprises a sixth processor for using the first information to generate a model light source pattern for approximating the at least one light source, the model light source pattern comprising one of:
a point intensity pattern; and
a distributed intensity pattern having a non-zero, approximately uniform intensity value within a light source region having a selected geometric shape, the distributed intensity pattern having an approximately zero intensity value outside the light source region.
